(19) United States
(12) Patent Application Publication
(10) Pub. No.: US 2009/0240381 A1
(43) Pub. Date: Sep. 24, 2009

(54) METHOD AND APPARATUS FOR CONTROLLING POWER CONSUMPTION

(75) Inventor: Mark E. Lane, Woodstock, GA (US)

Correspondence Address: BACHMAN & LAPOINTE, P.C., 900 CHAPEL STREET, SUITE 1201, NEW HAVEN, CT, 06510, US

(73) Assignee: RTP CONTROLS, Woodstock, GA (US)

(21) Appl. No.: 12/294,256

(22) PCT Filed: Mar. 26, 2007
(86) PCT No.: PCT/US07/07537

§ 371 Date: Feb. 25, 2009

Related U.S. Application Data
(60) Provisional application No. 60/785,509, filed on Mar. 24, 2006.

(51) Int. Cl. G06F 19/00

(52) U.S. Cl. 700/296; 700/286

(57) ABSTRACT

Methods and systems are disclosed for controlling energy consumption at a facility, or a group of facilities, using current and future energy prices, and seasonal and environmental information to control a load shedding scheme.

### REFERENCE TO RELATED APPLICATION

This application claims the benefit of U.S. Provisional Application No. 60/785,509, filed on Mar. 24, 2006, which is incorporated herein by reference in its entirety.

### BACKGROUND OF THE INVENTION

The invention relates generally to the field of controlling power consumption. More specifically, the invention relates to methods and systems for controlling energy consumption at a facility, or at a group of facilities through aggregation using current and future energy prices, seasonal and environmental information, demand response signals, and requests from energy providers to control a load shedding scheme.

Utility companies charge consumers or end users according to a policy that encourages energy conservation. Utilities assess the cost for acquiring and maintaining extra power generating equipment to meet peak demands against end users who create the peak demand.

Utilities will typically charge customers at a first rate for electricity consumed below a first predetermined level and at a second rate for electricity consumed between the first level and a second predetermined level. If electrical power consumption exceeds the second level, a penalty or surcharge is charged to the end user. The surcharge accounts for the extra generating capacity the utility may have had to acquire, or build and maintain to meet those periods of unusually high or peak demands.

To avoid peak demand charges imposed by a power utility, high consumption end users have employed automatic control systems which monitor power consumption within their facilities and then modify the on/off status of predetermined power consuming loads within the facility to maintain power consumption below a setpoint. These systems are referred to as add/shed control systems.

The systems are designed to shed loads as power consumption exceeds a setpoint chosen by a facility. As power consumption decreases and falls below the setpoint, loads that were shed may be returned to service.

Today's energy saving and cost reducing strategies consider a facility's power consumption based on power consumption setpoints. This type of control uses an electrical load shedding setpoint. When the power consumption reaches that setpoint, or is forecast to reach that setpoint, an electronic controller starts reducing electrical loads until the current power consumption is maintained below the setpoint. This strategy works well for reducing total power consumption and peak demand.

There are many types of strategies as to what loads are shed during this power reduction mode. For example, in office buildings, one strategy may allow the temperature in the building to rise a few degrees during warm weather, or in a food market, one strategy may shed some lighting and refrigeration loads.

No matter which strategy is used, the controlling factor is the setpoint that allows only a predetermined amount of power to be used within a specified time window. When the allowed amount is exceeded, or is predicted to be exceeded, the control strategy begins to remove power consuming loads from service until the consumption is maintained below the allowed amount.

There is an inherent drawback to these strategies. If a device is consuming power, it is operational for a reason. For example, in a supermarket, refrigeration accounts for the largest consumption of power, consuming about 40% of the supermarket's total electrical usage. When refrigeration is shed for energy savings, it may be detrimental to the refrigerated product. This type of strategy can affect such things as increased product loss and reduced shelf life. If load shedding is implemented without safeguards, some of these energy saving strategies would hamper the ability to maintain food safety standards.

In an office environment, increasing temperature setpoints can result in an uncomfortable work environment, impacting efficiency and production. Almost without exception, today's control strategies save energy at the cost of a desired condition (cold products, cool or warm offices, extra lighting, etc.).

In the past few years, the electrical power industry has started deregulation in many states. Deregulating electricity will allow consumers to purchase electricity as a commodity on a spot market. The spot market and spot price is where commodities are bought and sold for immediate delivery. The price in a futures market depends in part on the price on the spot market. The spot energy market allows producers of surplus energy to locate available buyers for this energy, negotiate prices and deliver actual energy to a customer in just a few minutes.

Under most of the current deregulation legislative approaches, an end user is given the opportunity to purchase electric power from any power utility willing to supply electric power to the end user's geographic region. The increased competition will ultimately reduce the end user's energy cost. As competition increases, power generators are expected to offer customers various pricing plans, including, for example, plans based on volume and term commitments, and/or on-peak/off-peak usage.

It is anticipated that the local distribution company facilities of the local electric utility would continue to be a regulated monopoly within the region it serves. These facilities are primarily the lines and other equipment that constitutes the local power grid over which electric power is delivered to the end user, having been delivered to the grid by generating plants within the local utility service area or by other utilities' grids interfacing with the local utilities grid.

The electric utility primarily relies on meters at customer sites to apprise the utility of how much energy the customer has consumed. Many of these meters measure the energy used and may provide more detailed, itemized information.

The inventor has recognized that deregulation of electric utilities creates an opportunity for load shedding and load consuming strategies that take advantage of this new method of buying electricity as a commodity on the spot market. Accordingly, it would be desirable to provide a system and method that allows end users to configure a load shedding scheme based on current and future energy costs.

### SUMMARY OF THE INVENTION

Although there are various methods and systems for shedding facility loads based on consumption and the price of energy, such systems and methods are not completely satisfactory. The inventor have discovered that it would be desirable to have methods and systems that may reduce energy consumption, or increase energy consumption, using current and future energy prices, seasonal and environmental information, demand response signals, and requests from energy providers to control a load shedding scheme for control.

One aspect of the invention provides methods for controlling energy consumption for a facility. Methods according to this aspect of the invention preferably start with setting an energy reduction threshold, monitoring a market indicator, providing a time of day schedule for the facility wherein the schedule determines available time periods when energy consumption may be reduced, and controlling the facility energy consumption by shedding facility loads if the energy reduction threshold is less than the market indicator and the time of day schedule allows for shedding loads.

Yet another aspect of the method is acquiring future market indicator information for the facility and providing an energy calendar from the acquired market indicator information for the facility.

Another aspect of the method is assigning at least one sheddable load to at least one level.

Another aspect of the method is wherein each level further comprises an energy reduction threshold wherein each level has a different threshold and functions as a step-response load shed in response to changing market indicators.

Another aspect of the method is comparing an energy reduction threshold with a market indicator supplied to the facility, retrieving the weather calendar if the market indicator for energy is greater than the energy reduction threshold, and adjusting at least one temperature setpoint a predetermined number of degrees, higher or lower corresponding to cooling or heating, for temperature controlling equipment located at the facility in correspondence with the weather calendar to reduce anticipated facility energy consumption.

Another aspect of the method is choosing a plurality of facilities as a group for group control, setting at least one group energy reduction threshold, monitoring a market indicator for energy supplied to the group, providing a time of day schedule for the group wherein the schedule determines available time periods when the group may reduce consumption, and for each facility in the group, shedding facility loads as determined by the group control corresponding to at least one energy reduction threshold if the energy reduction threshold is less than the market indicator and the group time of day schedule and each facility time of day schedule allows for shedding.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary distributed system diagram according to the invention.

FIG. 2 is an exemplary schematic of a facility controller according to the invention.

FIG. 3 is an exemplary application framework of the individual modules of the invention.

FIG. 4 is an exemplary facility configuration method.

FIG. 5 is an exemplary facility control method.

FIG. 6 is an exemplary facility control method outside of its TOD schedule.

FIG. 7 is an exemplary group facility control method.

FIG. 8 is an exemplary group facility control method outside of the TOD schedules for group members.

### DETAILED DESCRIPTION

Embodiments of the invention will be described with reference to the accompanying drawing figures wherein like numbers represent like elements throughout. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

The invention is not limited to any particular software language described or implied in the figures. A variety of alternative software languages may be used for implementation of the invention. Some components and items are illustrated and described as if they were hardware elements, as is common practice within the art. However, various components in the method and system may be implemented in software or hardware.

Embodiments of the invention provide methods and systems that allow a user to control power consumption for a facility, or group of facilities, based upon regional energy pricing, regional energy supply, and the environmental conditions at the facility location. The application functionality monitors the power consumed by subscribed users in conjunction with the price of energy supplied to them by their electric utility, and the supply and demand of their electric utility.

Each subscriber configures a load shedding scheme for a facility that allows for the shedding of predetermined loads and loads controlled by external building automation systems, depending on the facility's energy consumption, the current energy commodity market prices, future or ahead energy market prices and the current supply levels of energy from their local utility. Other options are available depending upon the needs of a facility or group of facilities. Although exemplary embodiments are described herein with reference to particular network devices, architectures, and frameworks, nothing should be construed as limiting the scope of the invention.

In one embodiment, the invention is deployed as a network-enabled framework and is accessed using a graphical user interface (GUI). The application code resides on an application server or a plurality of application servers, and is accessed by users via a client application such as a Web browser (Mozilla Firefox, Netscape, Microsoft Internet Explorer and others) or via another client access software application that is not a general-purpose browser. This access takes place over a distributed transaction system using custom or standard Internet languages and protocols, and may involve scripting languages including HTML (Hypertext Markup Language), dynamic HTML (DHTML), Microsoft VBScript (Visual Basic Scripting Edition), Jscript, ActiveX, XML and Java.

A user's client application contacts the server hosting the application. The server sends information to the client application which displays the results to the user.

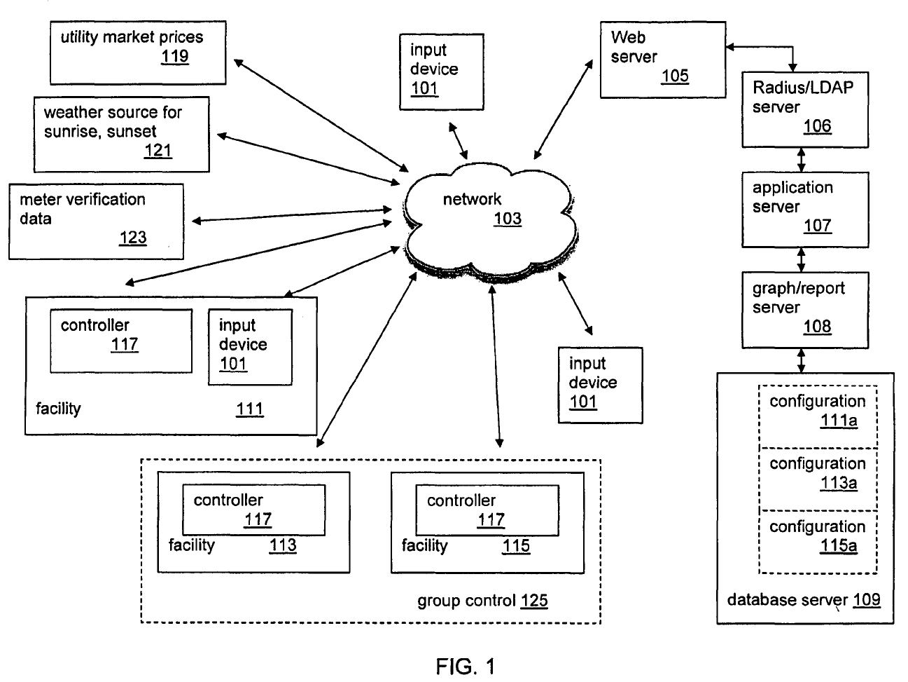

Show in FIG. 1 is an overall distributed system view of the invention. The invention is a modular framework and is deployed as software as an application program tangibly embodied on a program storage device. Users access the framework by accessing the GUI via a computer 101.

A communications network 103 may be a single network or a combination of communications networks such as the Internet including any wireline, wireless, broadband, switched, packet or other type of network through which voice or data communications may be accomplished.

Most distributed transaction systems, such as Internet services, employ multi-tier architectures to integrate their components. Individual computers at a plurality of locations can communicate with a plurality of Web servers, which in turn communicate with other servers such as application and database servers. Referring to FIG. 1, a typical three-tier architecture is shown which includes a Web server 105 (Web tier), application server 107 (middleware) and database server 109 (database tier).

Since the invention is built using Web-based technology, and in one embodiment is an HTML based Web-enabled utility, an Internet browser using a communications network 103 may access the invention application. Individual computers 101 at a plurality of locations may communicate with the server hosting the application. The server stores operational instructions for the application, data, preferred modes of contact for users, and other storage needs. Users having authorized access can access the invention through a browser or other client access application, or application specific interfaces.

The invention framework may reside on at least one application server. The Web server 105 acts as an interface, or gateway, to present data to a client's browser. The application server 107 supports specific business or application logic which generally includes the bulk of an application. A back-end database server 109 is used for persistent data storage. A remote authentication dial in user service (Radius)/lightweight directory access protocol (LDAP) server 106 provides for a secure remote login. The graph/report server 108 provides graphs, reports, information and other metrics about shed events and market prices to an authorized user.

Computers 101 typically include a CPU, memory, a reader for reading computer executable instructions on computer readable media, a common communication bus, a communication suite with external ports, a network protocol suite with external ports and a GUI. The communication suite and external ports allow bi-directional communication between the computer, other computers, and external compatible devices such as laptop computers and the like using communication protocols such as IEEE 1394 (FireWire or i.LINK), IEEE 802.3 (Ethernet), RS (Recommended Standard) 232, 422, 423, USB (Universal Serial Bus) and others.

The network protocol suite and external ports allow for the physical network connection and collection of protocols when communicating over a network. Protocols such as TCP/IP suite, IPX/SPX (Internetwork Packet eXchange/Sequential Packet exchange), SNA (Systems Network Architecture), and others. The TCP/IP suite includes IP, TCP, ARP (Address Resolution Protocol), and HTTP. Each protocol within a network protocol suite has a specific function to support communication between computers coupled to a network.

The GUI includes a graphics display such as a CRT, fixed-pixel display or others, a key pad, keyboard or touchscreen and pointing device such as a mouse, trackball, optical pen or others to provide a user interface for the invention.

The computer 101 may be a handheld device such as an Internet appliance, PDA (Personal Digital Assistant), RIM Blackberry, or conventional personal computer such as a PC, Macintosh, server, or UNIX based workstation running their appropriate OS capable of communicating with a computer over wireline (guided) or wireless (unguided) communications media. The invention may also be practiced on platforms and operating systems other than those mentioned.

The computers 101 access the application server 107 hosting the invention application via the network 103. At a facility 111, 113, 115, a local control interface or controller 117 is installed for controlling facility loads, communicating with building automation systems (not shown), and for facility data acquisition.

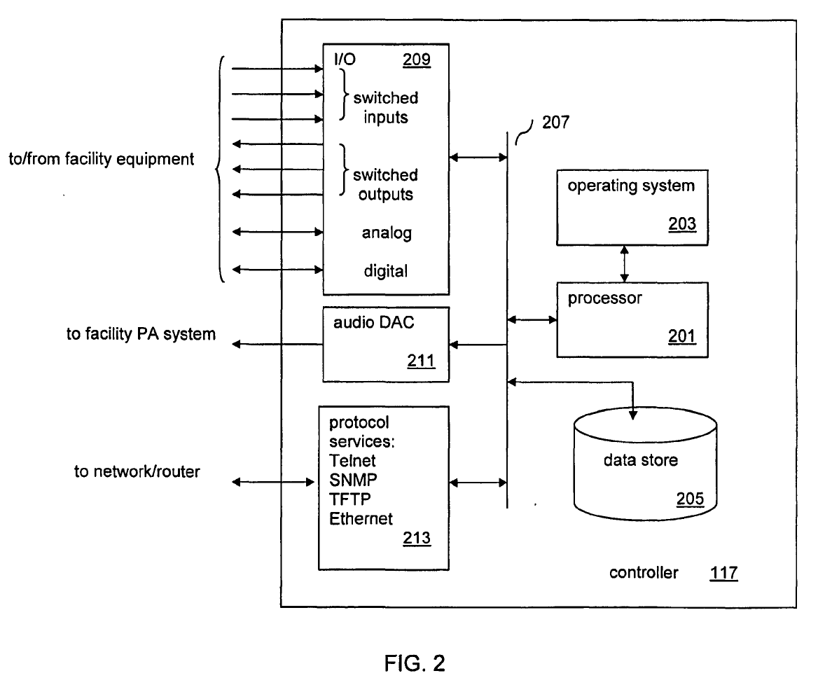

The controller 117 is shown in FIG. 2. The controller 117 comprises a processor 201, an operating system (OS) 203, a data store 205, a communication bus 207, an external control connection (I/O) 209, an audio output 211 and a communications interface 213. The communications interface 213 couples to a router, a network connection (not shown), a radio or cellular modem, or wireless modem for communication with the network 103.

The I/O 209 may comprise switched outputs for controlling loads, switched inputs for acknowledging a load state, analog outputs for controlling modulating loads, and analog inputs for data acquisition such as temperature, humidity, CO and CO₂ levels and others, and configurable digital interfaces. The I/O 209 is expandable regarding the number and type of I/O points. Other I/O configurations are possible. The I/O 209 may couple directly or indirectly (using a building automation system or a demand controlled ventilation system) to loads and other facility devices for control.

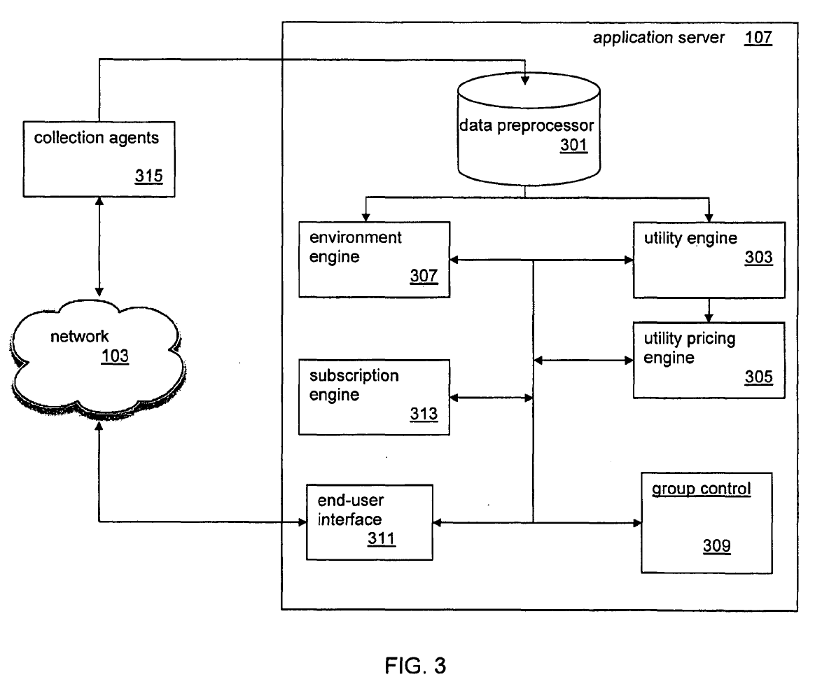

Preferably, the invention framework is secure and allows effective integration of database information and external Web services through a set of software and hardware modules. Shown in FIG. 3 is a framework of the various modules that comprise the application server 107. The framework comprises a data preprocessor 301, a utility engine 303, a utility pricing engine 305, an environment engine 307, a group controller 309, an end-user interface 311 and a subscription engine 313. The framework solicits and receives data from monitoring agents and sensors 315 in the distributed transaction system.

The subscription engine 313 is a software module that accepts information from external systems, third parties and Web Services, and converts them using a normalizer into a compatible format for the framework. The subscription engine 313 supports XML (eXtensible Markup Language). The subscription engine 313 subscribes for information from external systems such as sites for utilities serving a facility and energy pricing 119, environmental and weather conditions for where a facility is located 121, meter verification data 123, Open Access Same Time Information Systems (OASIS), system supply limitations and others. Upon receiving and normalizing information, the subscription engine 313 forwards the information to the utility 303 or environmental 307 engines for further processing.

The subscription engine 303 allows each external system to be subscribed to, thereby exposing information. The invention framework knows each of the external systems a priori by URL (Uniform Resource Locator) or by search engine if unreachable or not known. The subscription engine subscribes for regional information for a particular facility or periodically for facility related update information. The subscription engine 313 submits the received information to the environment 307 or utility 303 engines for further processing.

The environment engine 307 monitors conditions for each subscribed facility such as facility temperature, weather forecasts, available daylight, and other information. The environment engine 307 monitors the regional weather conditions that a subscribed facility may experience regardless of location. The utility 303 and utility pricing 305 engines process utility pricing information associated with each subscribed facility. Group 125 control 309 maintains facility grouping assignments.

The end-user interface 311 provides abstract notification rules that can select one or multiple relevant targets and notify them via various channels. The interface 311 routes notification information such as email, IM (instant messaging), phone, PDA, and others, with two-way communication capability to multiple devices.

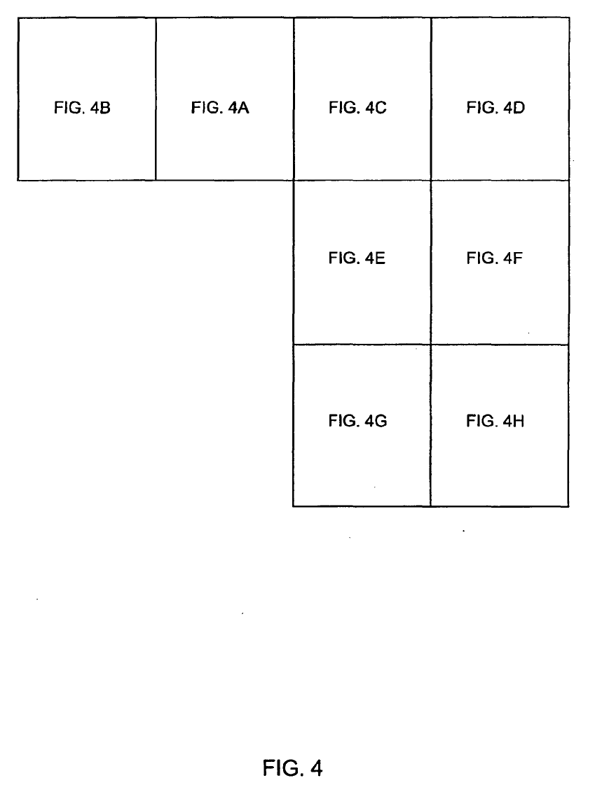

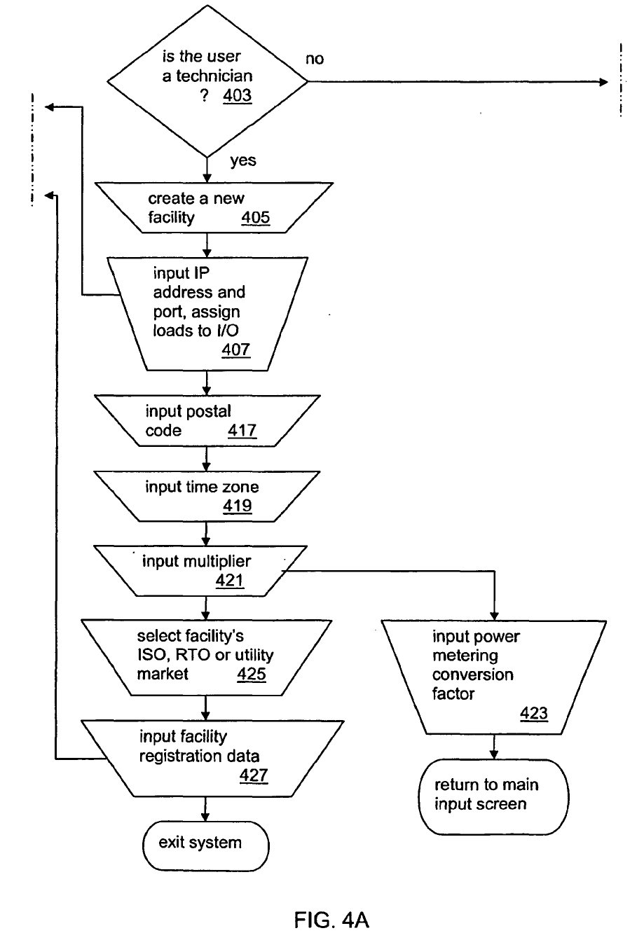

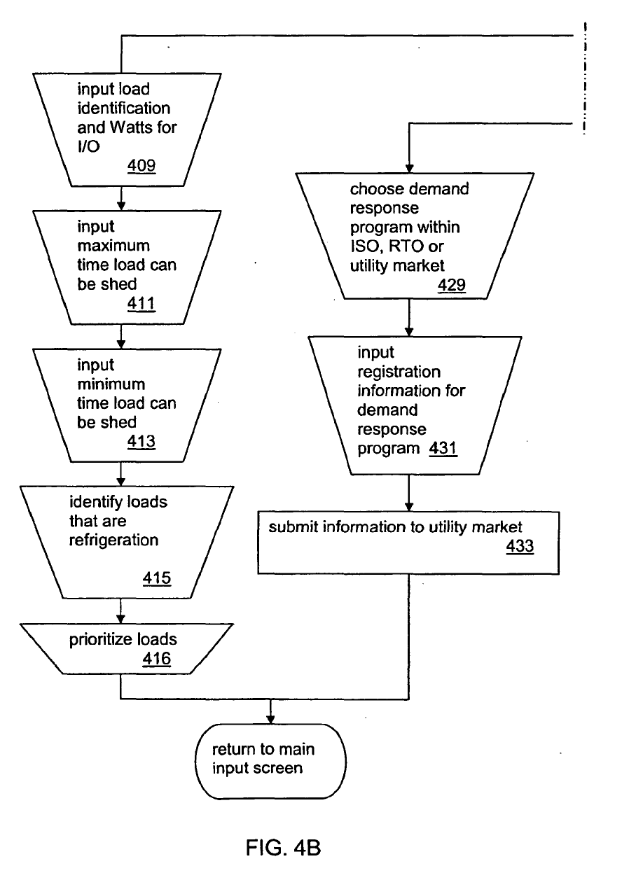

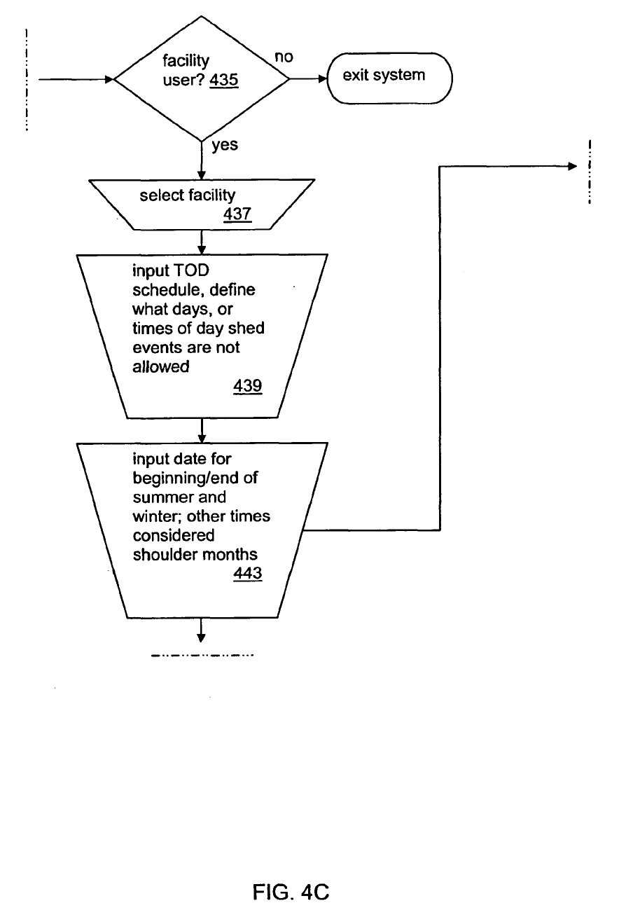

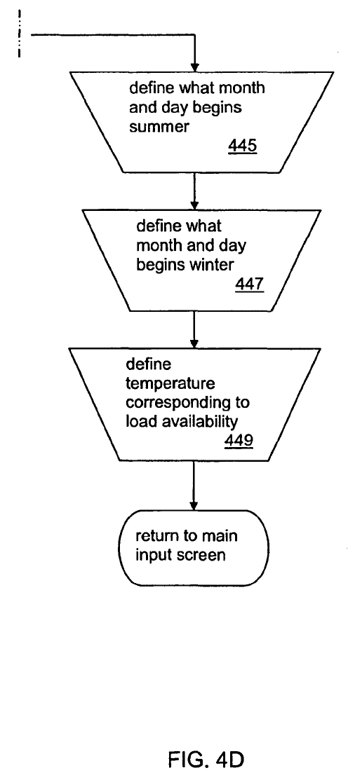

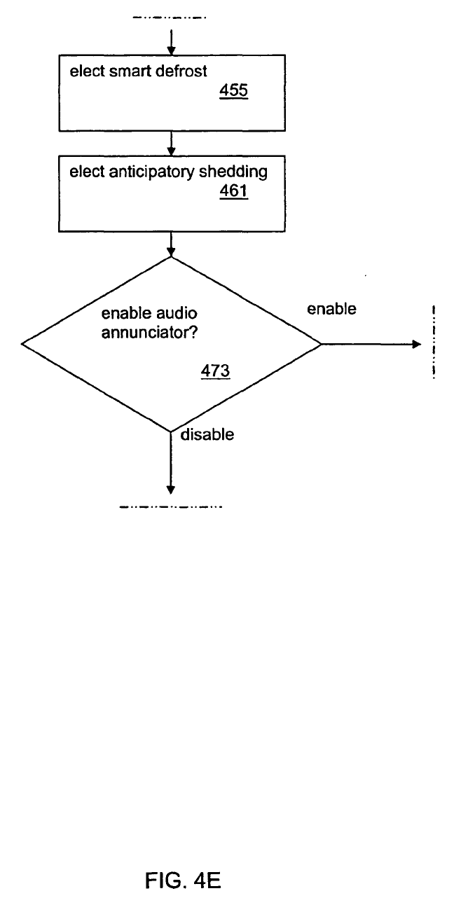

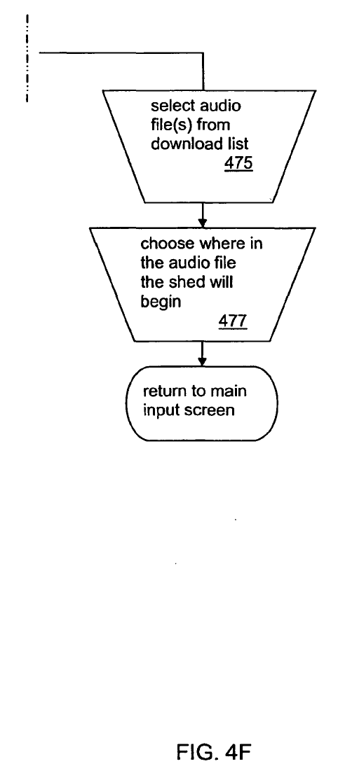

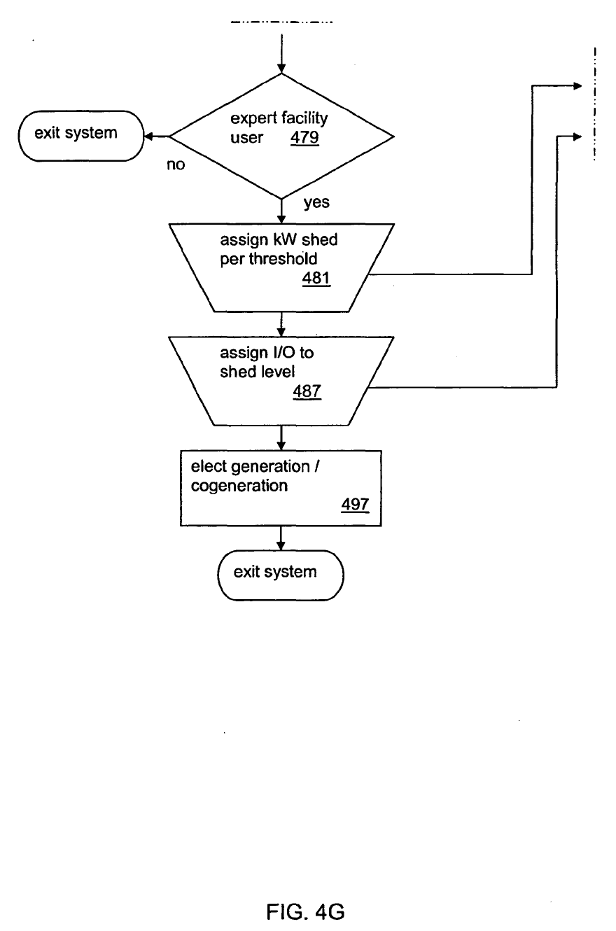

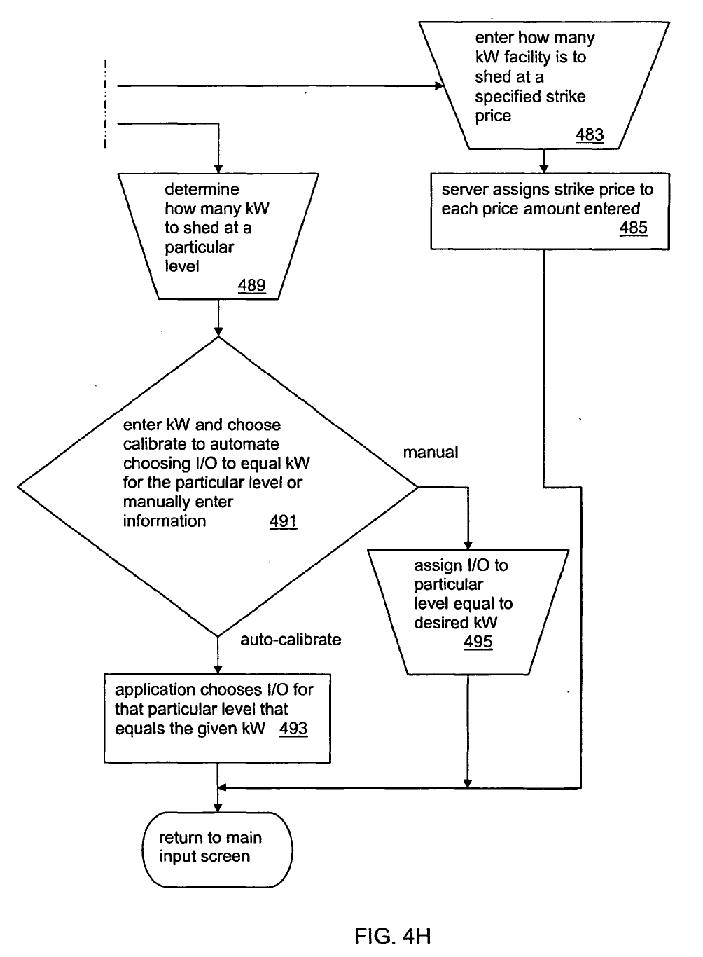

Shown in FIG. 4 is a facility configuration. At least one controller 117 is provided for each subscribed facility 111, 113, 115. The I/O 209 couples with external switchgear, shunt-trip breakers, local instrumentation including power metering and other process control devices located at the facility. The communication interface 213 is capable of a plurality of communication protocols, such as Ethernet, for communicating with the server 107 or servers hosting the invention framework over the communications network 103.

Configuration may be performed from any computer 101 over the network 103. Facility configurations are performed by the application server 107 and stored in the database server 109. The instructions pertaining to a facility are executed when a configuration change is confirmed. The controller 117 does not affect facility operation unless instructed by the application server 107 in conjunction with a facility's configuration 111a, 113a, 115a when load shedding, or when additional consumption conditions are determined to be favorable.

Using a computer 101, a user opens a browser (from any location) and accesses the server 107 hosting the invention. The application server 107 downloads a login view where the user enters a username and password.

If the user is an authorized technician (step 403), he may create a new facility identification (step 405) during an initial configuration. A unique and constant IP address is assigned to every facility controller 117 to allow for uninterrupted communication between the application server 107 and every facility controller 117.

The user configuring the facility determines which loads it can shed and which loads can be used for reciprocal control (step 407). Typical facility loads may include refrigeration units, unit heaters, unit coolers, ventilation fans and dampers, indoor lighting, outdoor lighting, shunt-trip breakers controlling loads and others. Facility circuits that can be shed are identified and are coupled either directly to the controller 117 I/O 209 or indirectly. For example, if a building automation system is employed at a facility to monitor and control loads such as refrigeration, the controller 117 may interrogate the building automation system using the digital interface 209. Each facility load controlled by an I/O point, or indirectly using a building automation system or demand controlled ventilation system, has a known power consumption in Watts. The load values may be nameplate ratings or may be found empirically.

Each load controlled by controller 117 I/O 209, or indirectly by a building automation system is entered (step 409) into the facility configuration 111a, 113a, 115a, identified by equipment identification and applicable characteristics. All assigned I/O 209 are identified by equipment and indicate, for example, load (power consumption in Watts), temperature (° F.) or CO, CO₂ (ppm) if an analog input, building automation system communications if a digital link and other process inputs.

Each I/O point 209 controlling a load has an equipment identification, a load amount, and may be assigned a numerical priority. Each load may be controlled individually, or may be assigned to a predetermined level which may include a plurality of assigned switched outputs equaling a predetermined load amount. Each level may include an energy threshold or setpoint as a step-response load shed to increasing market indicators.

After the I/O is assigned for a facility, the user may access a view that allows for limiting the time a load may be shed, such as the maximum amount of time the load may be shed for (step 411) and the minimum amount of time the load may shed for (step 413). Categories such as whether the I/O point controls refrigeration (step 415), priority (step 416) and other parameters may be entered. For example, whether an I/O point controls a refrigeration unit having a forced defrost.

If an I/O point controls refrigeration having a forced defrost cycle, once the maximum shed time has been reached, the application instructs the building automation system coupled to the refrigeration unit to run a forced defrost cycle when the refrigeration unit is returned to service, or in the case of reciprocal control forcing a defrost at a time when the market indicator is below the energy consumption threshold.

A user may choose whether the application determines which individual loads are to be shed, based on the shed amount that is called for, or in conjunction with priority, or whether shedding predetermined levels is desired. The levels are chosen based upon the shed amount called for and are combined to equal within a predetermined ranges approximating the shed amount. A user may also choose whether the application determines which individual loads are to run energy consuming tasks, based on the consumption amount called for, or in conjunction with priority, or whether energy consuming predetermined levels is desired. The levels are chosen based upon the consumption amount called for and are combined to equal within a predetermined range approximating the shed amount.

To establish a facility's physical location, the facility's postal zip code may be entered during configuration (step 417). Upon receiving the zip code, the application may send agents to subscribe to and obtain information on local environmental conditions such as temperature and weather forecasts, hours of available daylight, and other local information, and utility information.

The user enters the facility's time zone (step 419) and whether the facility location observes daylight savings, and a facility multiplier (step 421) if required. The multiplier is a conversion factor which converts the output from a facility's power metering into energy (kWh) (step 423). If the facility's power metering is intelligent and outputs energy, no multiplier is required.

After the controller 117 I/O 209 is assigned and the above information entered, a basic facility configuration 111a, 113a, 115a is complete. The application server 107 acknowledges and provides a drop-down menu showing the regional utilities found that serve the area where the facility is located and all configuration information. The user may select a utility, a Regional Transmission Organization (RTO), an Independent System Operator (ISO), and/or other similar entity for supplying, or managing the transmission of power (step 425).

An RTO is an organization that is established to control and manage the generation and distribution of electricity over an area that is generally larger than the typical power utility's distribution system. In the United States, an ISO is a federally regulated regional organization which coordinates, controls and monitors the operation of the electrical power system. It also acts as a marketplace in wholesale power since the electricity market deregulation. The Federal Energy Regulatory Commision requires open access of the grid to all electricity suppliers and mandated the requirement for an Open Access Same Time Information System (OASIS) to coordinate transmission suppliers and their customers. OASIS is a Web-based system for allocating electric power transmission service in North America. It is the primary means by which high-voltage (HV) transmission lines are reserved for moving wholesale quantities of electricity.

Since the functionality of the application finds which utilities provide power to a respective facility, or can provide power, the application determines and sends agents to the utility Web sites to query for energy pricing and other information such as energy supply shortages, or demand response signals. Energy prices are primarily related to an energy market. Typically, all utilities buy and sell energy at the market price and the functionality of the application retrieves the market price for energy corresponding to where a facility is located. If the information is available directly via URL, the application server 107 will establish a connection. If authentication is required, or if a direct connection is not available, the application server 107 will request the appropriate form or forms from the utility or market for manual completion and submission via an XML upload or by post (step 427).

In conjunction with choosing a utility or utilities to supply power, the user may elect to participate in a demand response program (step 429) sponsored by either a utility, an RTO, an ISO, or other similar entity.

One event that jeopardizes the integrity of any electrical grid is an extremely high electricity demand. These demands are typically experienced during extremely hot weather. There are times, usually once or twice a year, when the demands are forecasted to be higher than the available supply. Since this situation can potentially cause brownouts or even blackouts, RTOs, ISOs and local utilities may have demand response programs to reduce electricity demand during these periods of time.

Curtailment may be achieved using on site generation, or by a reduction in consumption. The amount of electricity that a facility curtails is determined by comparing the facility's metered load during the event against their peak demand average from the prior year. The facility may elect to participate in a demand response program. The facility will register with a service provider indirectly through the application server 107. The configuration (steps 431, 433) identifies what region a facility is located in and their registration will be submitted with their total MW reduction. When a demand response event occurs, a facility provides its agreed upon amount of load curtailment amount at that time.

To assist facilities that may not qualify for demand response programs that require a minimum amount of load, the invention allows for an aggregation of a number of small facilities that by themselves would not be able to participate due to their individual load reduction being too small. By aggregating a number of smaller facility's power reductions together, the invention allows each to participate in a demand response program.

After a technician performs a basic facility configuration, a facility user (step 435) configures the facility load shedding schedule and other options depending on what actions are desired. The facility user enters a user name and password, and selects an authorized facility (step 437).

The facility custom configuration is a TOD (time of day) schedule which acts as a load shed filter. An unconfigured TOD schedule is brought into view. The user mouses-over and highlights which days and times of the day for each calendar month are available for passive control (step 439). Out of the allowed times, passive control is highlighted for days and times when un-noticeable shed events are permitted. Un-noticeable shed events are for loads such as HVAC and others, where there would be no noticeable changes to normal conditions. Similarly, the user may highlight the TOD days and times when noticeable shed events are permitted. Noticeable shed events involve loads such as lighting and others, where there would be a slightly noticeable change to normal conditions. Active control is for those days when noticeable shed events are permitted.

A reciprocal of the TOD schedule allows for times when energy consumption may be increased to anticipate curtailment. If a load shed event will be forthcoming based on a facility's TOD and market indicator, certain load settings may be adjusted. For example, lowering the temperature of refrigeration units or lowering a facility's air conditioning setpoint, if those loads will be shed.

The user may input which days begin and end summer and which days begin and end winter (steps 443, 445, 447), or the application 107 may populate these dates automatically. The periods in between are referred to as shoulder months.

The user may define what temperatures the application considers as summer, winter or shoulder, and how much load is available for shedding during those periods (step 449). Some sheddable loads relate directly with temperature such as heating during winter months and HVAC during summer months. The functionality of the application is aware whether a building automation system may shed heating (if during winter months) or HVAC (if during summer months) since heating and HVAC represent different loads. Further, during summer months, refrigeration loads may be greater and may not be able to be shed for the same time periods as during winter months. The invention tracks the time of day and year to determine whether, for example, HVAC or lighting may be shed. When a predetermined temperature is reached, the application 107 knows how much load may be shed based upon the facility configuration.

After a user configures the facility controller 117 for regional information, and a TOD schedule is assembled, advanced options allow for a smart defrost and anticipatory shedding.

If a facility operates a plurality of refrigeration units, smart defrost (step 455) may be selected. Typical refrigeration units require periodic defrosting of their evaporator coils prior to frost and/or ice blockage. This may be performed using heaters, reversing compressor operation to produce hot gas, or de-energizing the unit. The invention provides an advanced feature for performing this activity. This aspect will be described below.

Anticipatory shedding (step 461) may be selected. Anticipatory shedding allows for certain adjustments to be made to a facility's configuration depending on the future price of energy. Anticipatory shedding will be described below.

The user may enable audio annunciation, or provide an output associated with a visual annunciation, such as a preprogrammed display (step 473). When enabled, the user may select an audio or video message(s) to be played at the facility during an active shed event (step 475). The user will select where in an audio or video message an active shed event may be triggered (step 477). Rather than selecting a prerecorded message, the user may type a message that will be generated into an audio or video announcement to be played during an active shed event. Within the message, the user may select various functions that the server will compute and enter into the message. For example, the user may define a function “A” that calculates the amount of kW/MW being reduced and multiplies that amount by the latest statistical information on the number of environmental emissions that are not being emitted when that amount of electricity is reduced. The predetermined function is inserted in a message and is initiated when the message is played. The calculation will be performed and synthesized into audio or video. Another example would be a function that relates the amount of kW/MW being reduced to a number of homes that may be powered with that amount of electricity.

If the user is an expert facility user (step 479), an energy reduction threshold may be entered. Typical expert users may include regional managers, energy procurement managers, or others. One or more energy reduction threshold may be entered that initiates a step-response load shedding (step 481). The user may select how much load may be shed at a particular market price (step 483). This is performed either by entering a load amount and letting the application decide which loads (I/O points) will be shed (step 485). This process is repeated for every energy reduction threshold the user enters.

When setting energy reduction threshold amounts, the user may decide on an amount of load (kW) to shed. The I/O is referenced to a predetermined amount of kW, so a user may enter, for example, 40 kW and the logic will automatically choose I/O that equals the same. Alternatively, the user may manually select loads totaling a predetermined amount. The number of possible energy reduction threshold levels is determined by the number of levels.

The expert user may assign facility loads to a plurality of individual levels (step 487), each corresponding to a different load amount (step 489). The application may automatically create shed levels based on the amount of kW reduction desired (steps 491, 493), or the user may create levels manually (step 495).

The expert user may elect to enable generation (step 497). Generation allows the facility to offset a load shed amount using onsite generated power. A generation threshold is entered to start an onsite generator and synchronize it with the facility distribution system. If the generating capacity is greater than what the facility consumes, the excess capacity may be output onto the utility grid, directionally metered, and sold. Generation is described below.

The user confirms that the facility configuration is complete and initiates application execution. The user then may log-off.

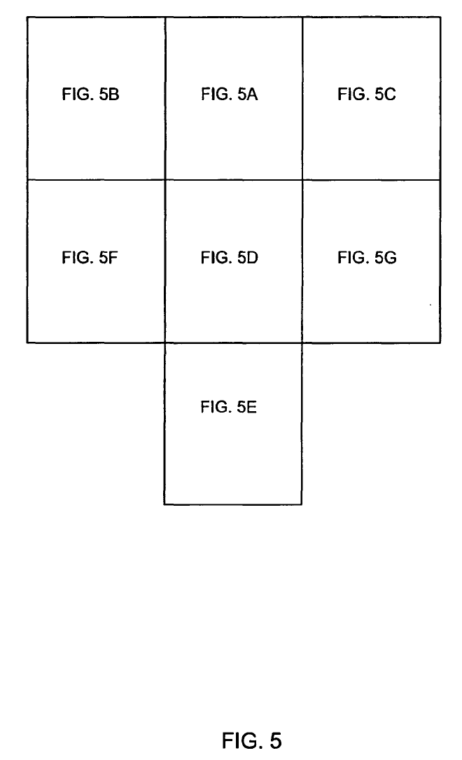

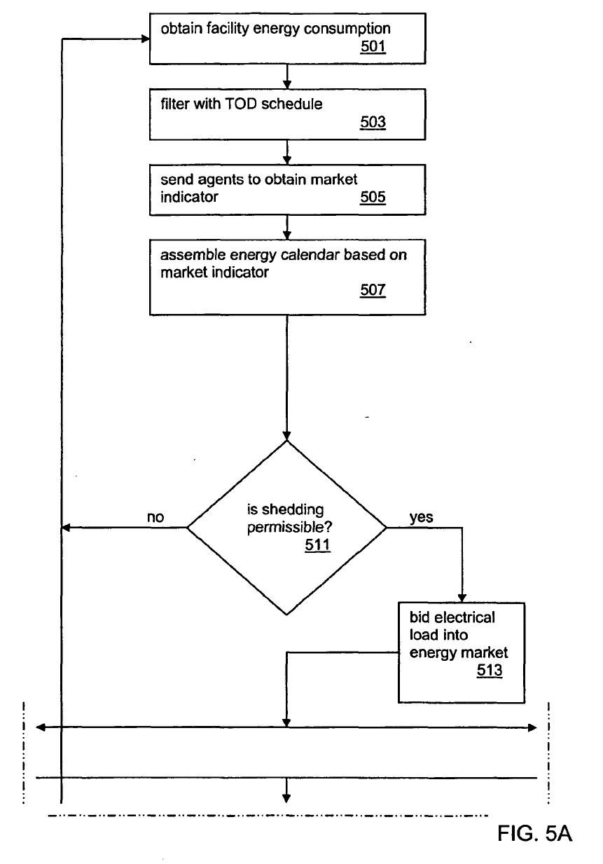

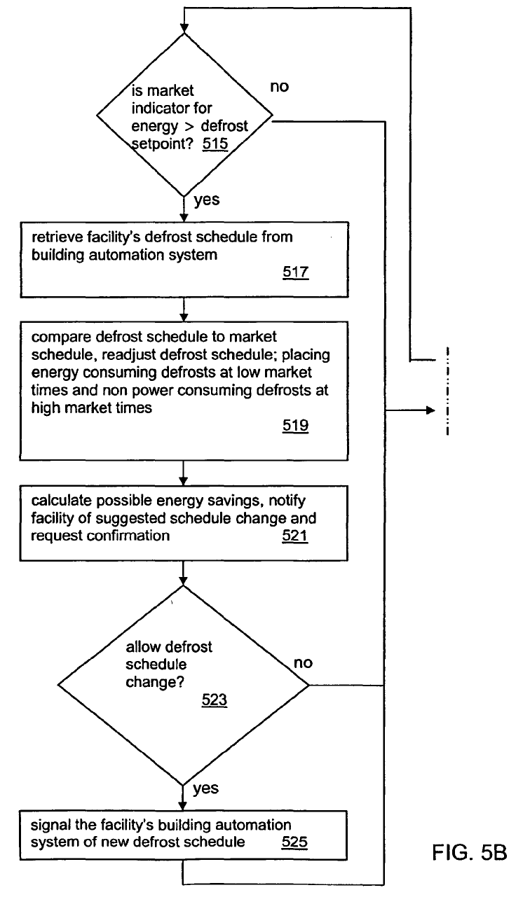

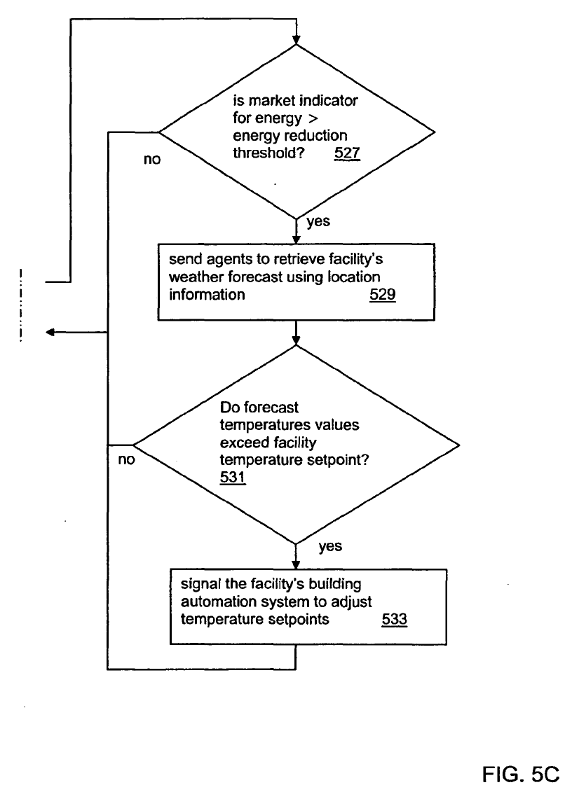

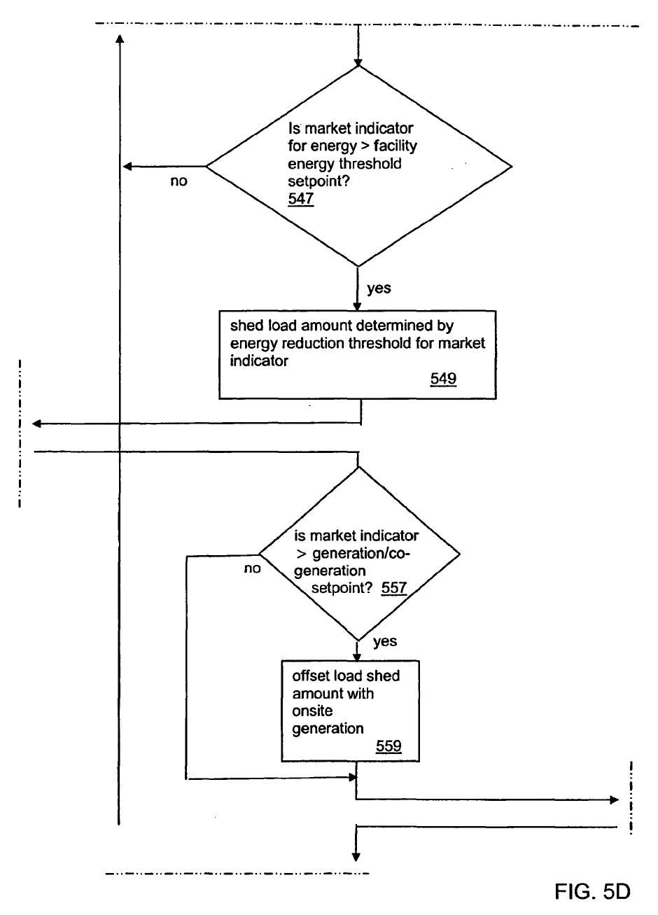

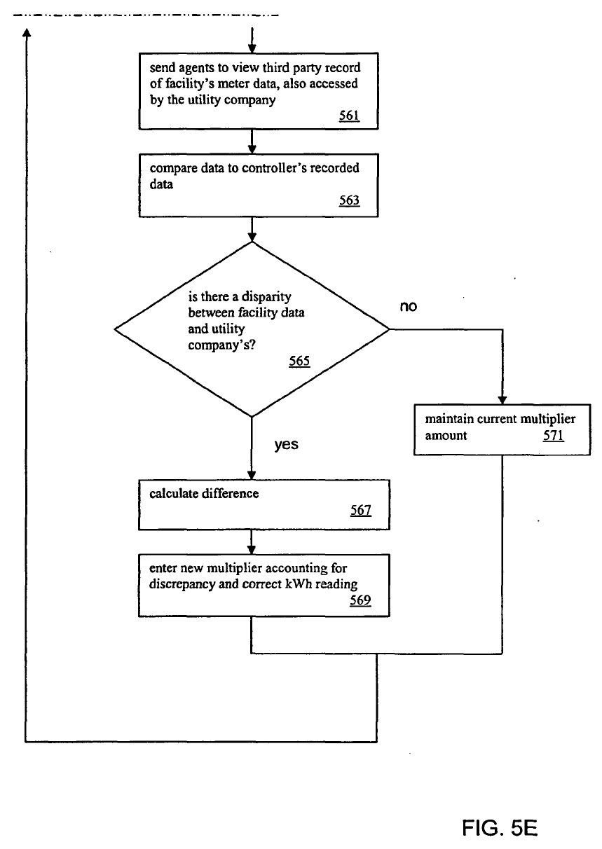

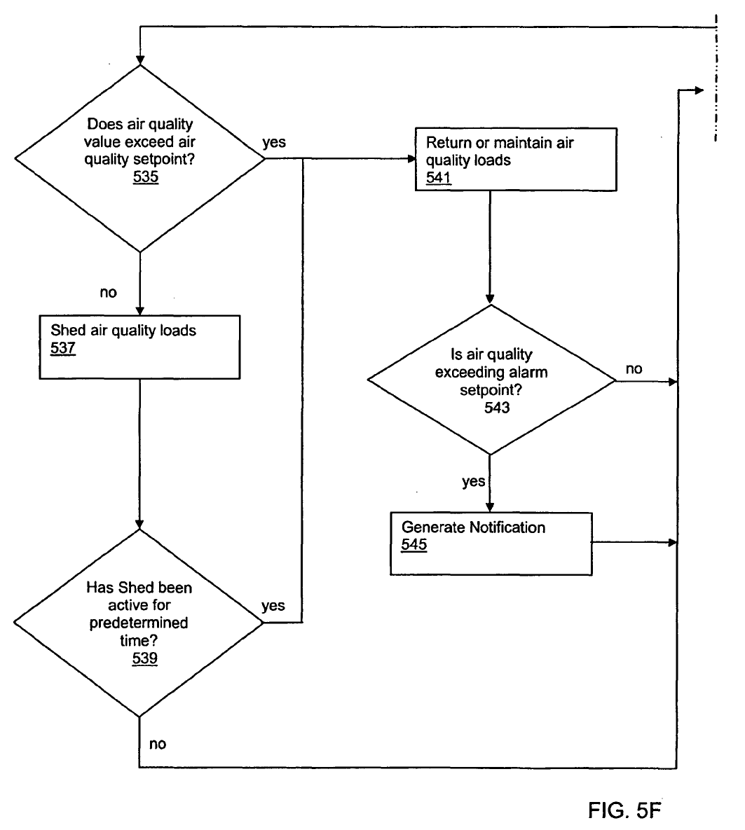

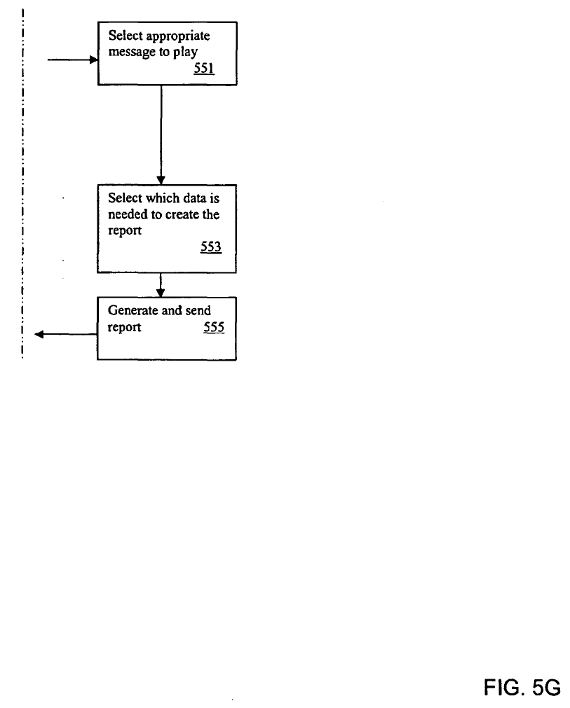

The functionality of the invention application is shown in FIG. 5. After a facility 111, 113, 115 is configured 111a, 113a, 115a, the application executes, and the respective facility's controllers 117 are in control. Each controller 117 receives and executes instructions generated by the application server 107 for that respective facility.

The application monitors a facility's power consumption (step 501). Power consumption may be stored for record keeping or archival purposes in either the respective controller's 117 data store 205 or the database server 109. Power consumption may be monitored continuously or at predefined intervals. With detailed information available for each facility, and for each facility's market, features such as stepped-response shedding, smart defrost and anticipatory shedding may be implemented. These features, if configured for a facility are filtered by a respective facility's TOD schedule (step 503)

The utility pricing information is made available and is correlated with each facility for future market indicator comparisons (step 505). Similarly, ahead market indicators (some demand response notices are hours before the event) for energy at future dates and times are gathered and correlated with each respective facility (step 507).

Facility prioritization (step 509) pertains to group level control and may be automatically determined by the amount of energy a facility may shed based on its TOD and other settings.

A respective facility's TOD schedule determines if shedding is permissible (step 511). If shedding is permissible, an amount of load is determined for a facility by its configuration. The amount of load that may be curtailed may be bid on the energy market (step 513). The server will submit to the RTO, ISO or local utility's energy market the amount of load available at particular hours in the form of a bid based upon a TOD. If there is a need for additional generation during those hours the RTO, ISO or local utility will accept the bid and pay the market price during those hours in which additional generation is needed. RTO, ISO and utilities that allow for this consider a reduction in consumption the same as a net effect in generation for those hours and therefore pay the current market rate for energy provided by reduction.

Facilities that house large capacity refrigeration units use building automation systems to perform routine defrosting operations. The system is input to the facility's controller 117 via an RS interface or other, to allow the controller 117 to interrogate the refrigeration control aspects.

If the market indicator is greater than a smart defrost setpoint (step 515), the application retrieves defrost schedules from the facility's building automation control system (not shown) (step 517). The application creates a first metric based on the market indicator, this metric could be based upon price of energy supplied to the facility, demand response signals or some other market indicator. Since a calendar of present and future market indicators have been assembled by the invention, the application accesses the energy calendar for times when defrosts are not presently scheduled, other than those signaled by the market indicator (step 519). A second metric is prepared from the defrost times schedule moved to future times when there is no market indicator. The second metric is compared against the first metric to show energy savings. The application forwards the new schedule along with the anticipated energy savings to the facility for acceptance (step 521). If the schedule is accepted by the facility user (step 523), the new schedule is used (step 525).

Similar to smart defrost, the application uses the energy calendar in conjunction with forecast environmental conditions for the facility. The application accesses a facility's configuration 111a, 113a, 115a. If the market indicator for energy is greater than an energy reduction threshold (step 527), the application 107 sends agents to retrieve the facility's weather forecast (step 529). For example, if the forecast temperatures are greater than a facility's temperature setpoint entered during configuration (step 531), the application will instruct the building automation unit to adjust HVAC temperature setpoints a predetermined number of degrees, either higher or lower corresponding to cooling or heating (step 533) to reduce energy consumption.

Indoor air quality, that may include CO, CO₂ or humidity levels, may be considered and compared to an air quality setpoint (step 535). If the CO, CO₂ or humidity levels are less than setpoint, indicating that the air quality is acceptable, loads such as ventilation system fans may be shed and any associated dampers closed (step 537). A maximum and/or minimum period of time that the air quality loads may be shed for is considered per the facility's configuration (step 539). If the time period is exceeded, the air quality loads return to service insuring that acceptable air quality standards are met.

The method controls the amount of outside air brought into a facility and provides the requisite amount of outside air for any occupants. This aspect saves energy by not heating or cooling unnecessary quantities of outside air and provides assurance that sufficient outside air is being supplied to the occupants. Additional components may include an economizer or air makeup unit with modulating dampers and control sensors to communicate with a facility controller 117. The components may include CO or CO₂ sensors, occupancy sensors, or turnstile counters.

If the CO, CO₂ or humidity levels are greater than or equal to the air quality setpoint (step 535), indicating that the air quality is unacceptable, the air quality loads are returned to service if previously shed or if off, or remain in service (step 541). If the CO, CO₂ or humidity levels become greater than a high level setpoint (step 543), an alarm sounds and notification, for example, an email, is dispatched to recipients on a notification list (step 545). To allow the air quality loads to be removed from service and prevent nuisance operation, a reset differential (deadband) is included such that the CO, CO₂ or humidity levels must fall below the setpoint and reset differential.

If shedding is permissible for a particular time and date (step 511) and if the market indicator is greater than the facility energy threshold (step 547), the invention sheds a load amount corresponding to the facility energy reduction threshold(s) (step 549).

If the facility is subscribed to a demand response program, the facility will acknowledge receipt of any demand response notices and accommodate the shed commands. The previously agreed upon load shed amount is performed. Depending upon the demand response program, demand response schedules are either filtered through the TOD or they bypass the TOD. If the demand response program is a mandatory program, the facility will bypass its TOD schedule and shed its agreed upon load amount. However, if the facility subscribed to a voluntary demand response program, all demand response notices will be filtered through its TOD, and other facility settings to determine availability of curtailable load. In addition, as some utilities, ISOs or RTOs step up their call for energy reduction through additional demand response signals, the facility interprets each new signal as a new energy reduction threshold and may increase, or decrease, its current load reduction amount accordingly. All demand response notices are communicated through the application server 107.

Depending upon the load shedding operations described above, and a facility's configuration, an audible message may be annunciated, or a video message shown in that facility prior to and/or intermittently during a curtailment event (step 551). In conjunction with the audible or visual message, a report may be generated (steps 553, 555). The report may be forwarded in accordance with any notification configuration for that facility.

If a facility has onsite generation capacity, the amount of load for a reduction in capacity may be offset by the amount of onsite generation capacity. If the market indicator is greater than a generation setpoint (step 557), the onsite generators may be started and placed on-line to lower a facility's power consumption (step 559).

As a measure of energy savings, the application may perform live data verification that adjusts the power metering conversion multiplier. Live data verification performs a check of the application's record of a facility's energy consumption against a third party's record (steps 561, 563) of the meter data. If there is a disparity between the facility controller's record and the third party's record (step 565), the application will calculate the difference (step 567) and assign the correct multiplier for the facility (steps 569, 571).

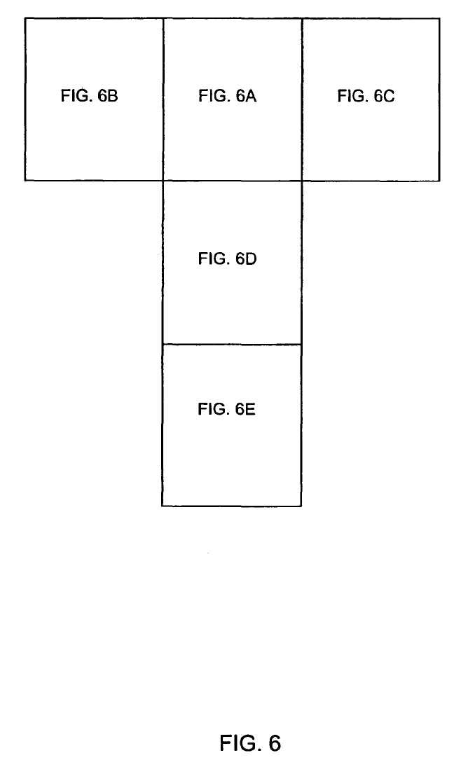

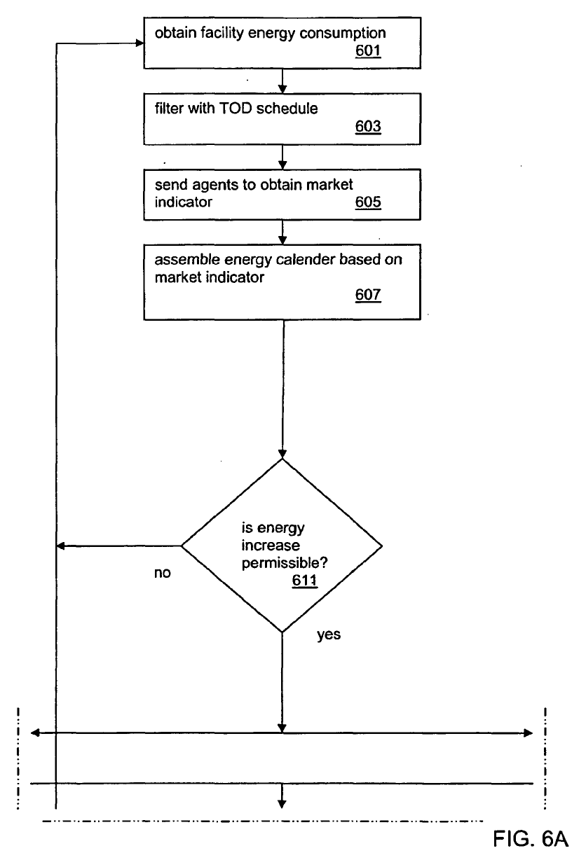

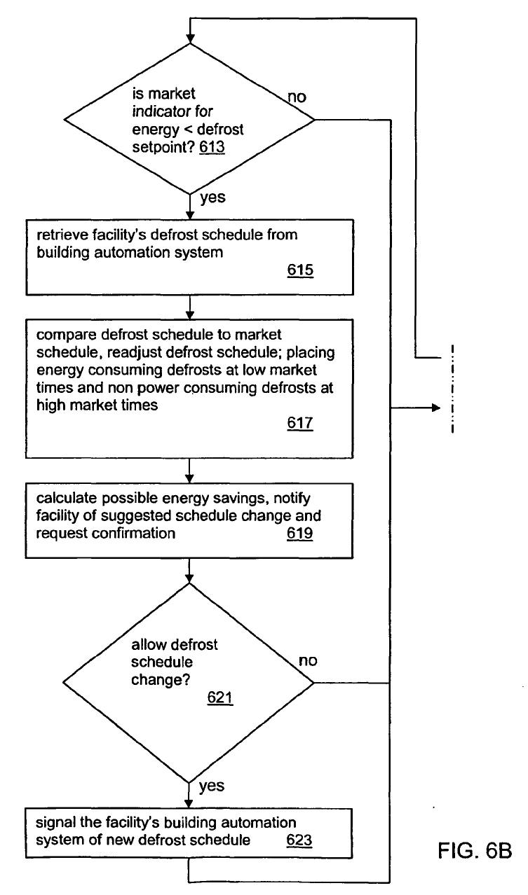

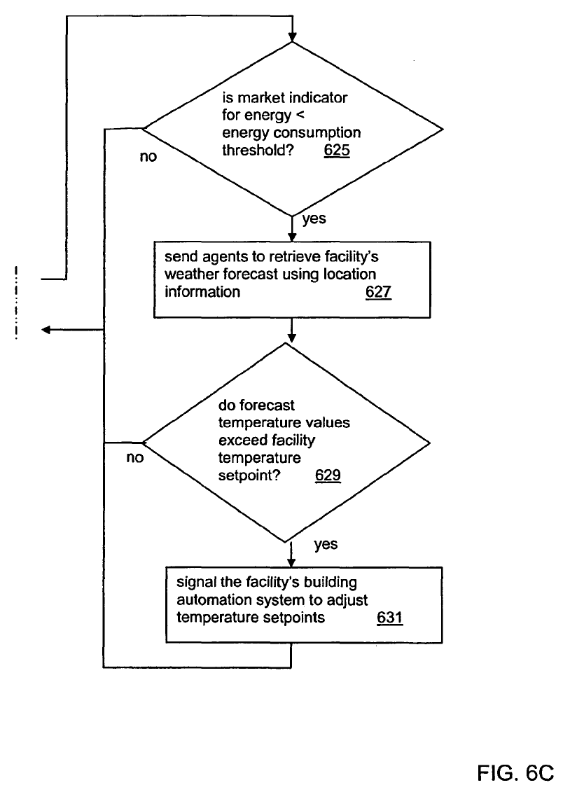

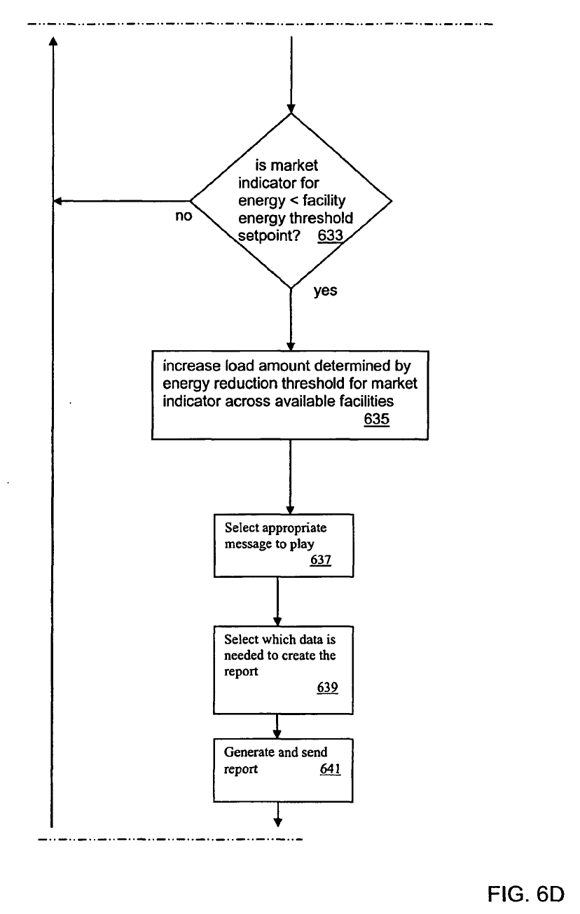

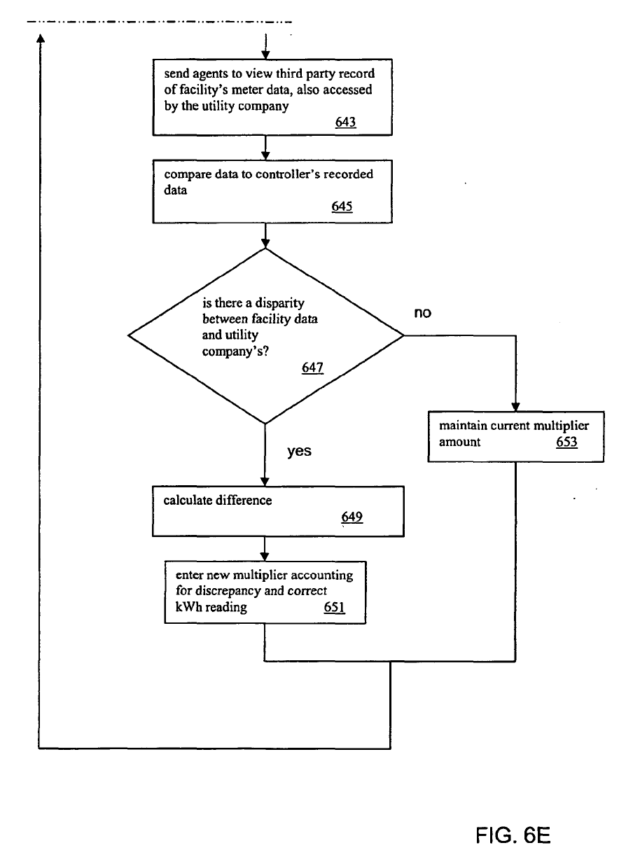

A reciprocal of facility control is shown in FIG. 6 and may be performed to increase load for those periods outside of the TOD to anticipate shedding, or to run those operations that consume excess energy during a low price time, or to consume less energy during a future demand response event. Similar to load reduction (steps 601, 603, 605, 607, 609), outside of the TOD, stepped-response shedding, smart defrost and anticipatory shedding may be optimized.

As above, utility pricing information is correlated with each facility for future price comparisons (step 605). Ahead market prices for energy at future dates and times are gathered and correlated with each respective facility (step 607).

A facility may be prioritized within a group of facilities. This prioritization is performed by the application and is contingent upon the availability of a facility to curtail load, or future availability to curtail load, in addition to the amount of current, or future curtailable load, and the length of time which current or future load may be reduced (step 609).

For load reduction, a respective facility's TOD schedule determines if shedding is permissible, however, outside of the TOD, load may be increased (step 611).

If a load increase is permissible, if the market indicator is less than a smart defrost threshold (step 613), the application retrieves defrost schedules from the facility's building automation control system (not shown) (step 615). The application creates a first metric based upon price for energy supplied to the facility, or some other market indicator. Since a calendar of present and future market indicators have been assembled by the invention, the application accesses the energy calendar for times when defrosts are not presently scheduled and other than those signaled by the market indicator (step 617). A second metric is prepared from the defrost times schedule moved to future times when there is no market indicator, or where the market indicator is a price, the price for energy supplied to the facility is less expensive. The second metric is compared against the first metric to show energy savings. The application forwards the new schedule along with the anticipated energy savings to the facility for acceptance (step 619). If the schedule is accepted by the facility user (step 621), the new schedule is used (step 623).

Similar to smart defrost, the application uses the energy calendar in conjunction with forecast environmental conditions for the facility. The application accesses a facility's configuration 111a, 113a, 115a. If the market indicator for energy is less than an energy reduction threshold (step 625), the application 107 sends agents to retrieve the facility's weather forecast (step 627). For example, if the forecast temperatures are less than a facility's temperature setpoint entered during configuration (step 629), the application will instruct the building automation unit to adjust HVAC temperature setpoints a predetermined number of degrees, either higher or lower corresponding to cooling or heating (step 631) to increase energy consumption.

If reciprocal control is permissible for a particular time and date and if the market indicator is less than the facility energy threshold (step 633), the invention consumes a load amount corresponding to the facility energy threshold(s) (step 635).

After a facility has initiated reciprocal control, a report may be generated describing the increased consumption measures taken by a facility, in addition to any related energy pricing information (steps 637, 639, 641). The report may be forwarded in accordance with any notification configuration for that facility.

As a measure of energy savings, the application may perform live data verification that adjusts the power metering conversion multiplier. Live data verification performs a check of the application's record of a facility's energy consumption against a third party's record (steps 643, 645) of the meter data. If there is a disparity between the facility controller's record and the third party's record (step 647), the application will calculate the difference (step 647) and assign the correct multiplier for the facility (steps 649, 651).

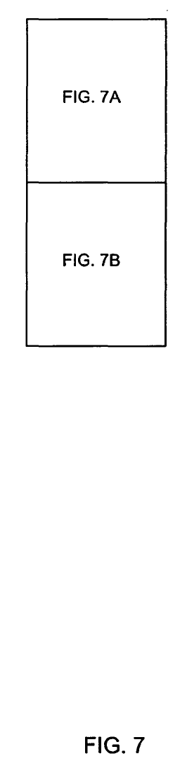

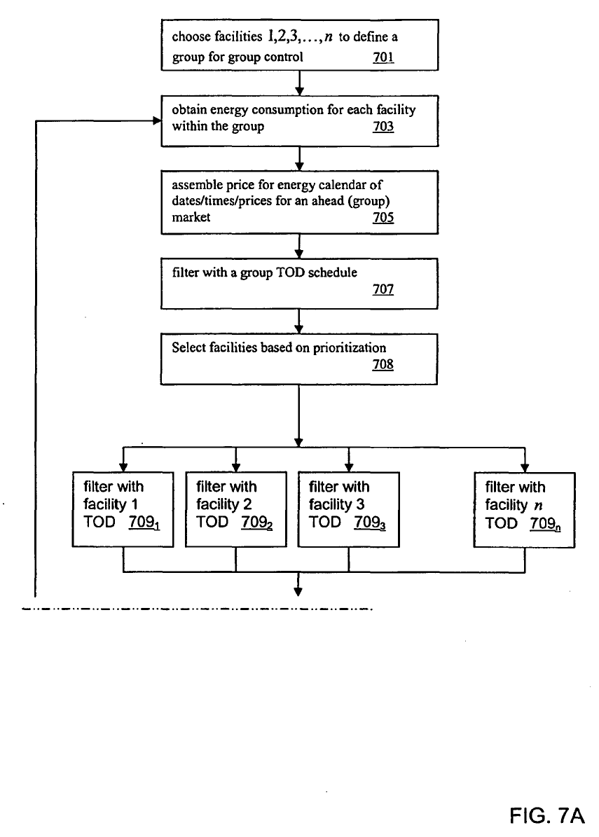

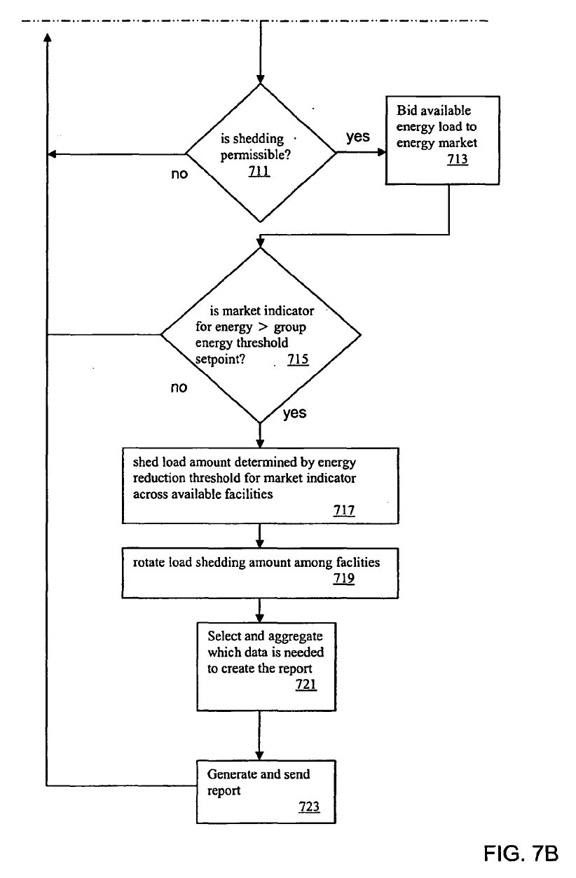

The invention further allows for a group control of a plurality of individual facilities as shown in FIG. 7. A group 125 may comprise at least two configured facilities 113, 115 either within the same market and enrolled in the same market programs, or in multiple markets. Where a group contains facilities located within different markets, the energy reduction threshold settings and other control settings will be controlled by the group. However, the facilities will respond to a market indicator from only their energy market.

An expert user may define a new group, or edit the configuration of a pre-existing group, while performing configuration (step 701). If configuring a new group, the user will enter in a new group name and assign configured facilities 113, 115 to that group 125. Since the application contains the configurations 113a, 115a of each facility 113, 115 in the group 125, group control links the configuration of each facility together for examination and combined control (step 703).

As previously discussed, the application server 107 continually retrieves the latest market prices for energy in day-ahead, hour-ahead, 5-minute ahead, or other time increments which are posted within a particular market and assembles a calendar of current and future energy prices (step 705). A market may include, but is not limited to, a group of utilities organized within an RTO, an ISO, a single utility, or other entity.

A TOD for the group is assembled and examined (step 707), and is subordinate to each facility's TOD (steps 709₁, 709₂, 709₃, . . . , 709ₙ). Facilities may then be prioritized based upon available energy reduction amounts, and the length of time of those energy reduction amounts. The application will then assign the amount of load to be reduced by each facility based upon its prioritization (step 708). Group energy reduction thresholds are determined with corresponding load shed amounts. The application compares the group's energy reduction threshold(s) against current market indicators. Each market indicator refers to a predetermined amount of load that will be shed, aggregating the amount of load to be shed over the group as a whole. Each group has its own step response.

The method will be repeated each time the market indicator changes to a new energy reduction threshold. This does not indicate that curtailment will change, but it may be reduced or increased.

The application examines the group and facility TODs (steps 707, 709₁, 709₂, 709₃, . . . , 709ₙ) if load shedding is allowed (step 711). The server will submit to the RTOs, ISOs or local utility's energy market the amount of kW available from facilities within the group the at particular hours in the form of a bid (based upon TOD) (step 713). If there is a need for additional generation during those hours the RTO, ISO or local utility will accept the bid and pay the market price during those hours in which additional generation is needed. RTOs, ISOs and utilities that do this consider a reduction in consumption the same net effect is generation for those hours and thus pay the current market rate for energy provided through reduction. If the current market indicator is greater than a group energy threshold (step 715), the application will correspond the group energy threshold with a predetermined amount of load that may be shed during that time. The predetermined amount of load to be shed is distributed across the members of that group (step 717). A group will not ignore a facility's energy threshold most of the time. The energy thresholds will be left blank at the facility level and default to the group, however, if a facility does have a different energy threshold, the system will not send that facility into shed until the energy threshold is met. This is performed by examining each facility's TOD within the group to see which facility allows load shedding during that period of time.

The application may notify the group's market(s) via notification such as e-mail, XML upload, or others, of the planned load reduction. The server schedules the shed event, calculates the amount of kW/MW that will be reduced, and forwards a message or uploads a file (whichever is appropriate for the market(s)) stating the above information and if applicable, the zones within the market where the reduction will be taking place.

The application takes into account the season of the year, referring to the predefined dates that begin and end the summer/winter/shoulder months. Each season and facility temperature will differ as to the amount of load available for shedding. One example would be HVAC loads that are not needed during moderate months, heating during winter which may use natural gas and consume less electric energy than cooling.

If a facility configuration includes anticipatory shedding, that facility is operating in an ahead-market, where the system will receive an ahead market indicator, allowing the application time to notify a building automation system, if present, of a need to adjust facility temperature to account for off-time during the hour(s) of load curtailment.

Group control allows for rotational shedding (step 719). The application will communicate with each facility in a group and determine how much load must be shed by each facility to attain the load determined by the group energy reduction threshold. The application instructs each controller 117 in a group 125 to enter that shed level. The application will rotate the amount of load to be shed to avoid burdening one facility with the entire amount. If the market price remains above the strike price the group will continue to shed, the application will request a greater load shed from other facilities within the group.

For example, facility 1 and facility 2 each have HVAC systems that consume 50 kW. Together as a group, 100 kW may be shed. However, due to seasonal demands, their HVAC systems may only be shut off for 2 consecutive hours, then an hour of recovery before another 2 hours. If the market price for energy remains at the group strike price level for 4 hours, the application may, on an hourly basis, rotate shedding between facility 1 and facility 2. During the first hour 1, facility 1 will be instructed to shed its HVAC system (50 kW savings). During hour 2, facility 2 will be instructed to shed its HVAC system (100 kW combined savings). During hour 3, facility 1 will energize its HVAC system (50 kW savings). During hour 4 both facilities HVAC systems will be energized. The next hour the rotation would begin again.

Rotational shedding may be any number of combinations, and rotates the demanded load that is to be shed among the facilities comprising a group during long periods of load curtailment. Rotational shedding is not limited to HVAC and may rotate lighting or any other load that may be controlled via the application.

Another group control option is Holiday scheduling. Holiday scheduling allows a user to place facilities within a group and shed loads during specific holidays. Unless configured at a facility level within their TOD, by default all holiday scheduling is controlled at the group level.

In addition to the above, the individual facilities continue to operate using their own facility configuration. Facility TOD schedules, enabling anticipatory shedding and similar processes are always preeminent over group controls. The application takes this into account when calculating group load available for reduction.

A report may be generated (steps 721, 723). The report may be forwarded in accordance with any notification configuration for that group.

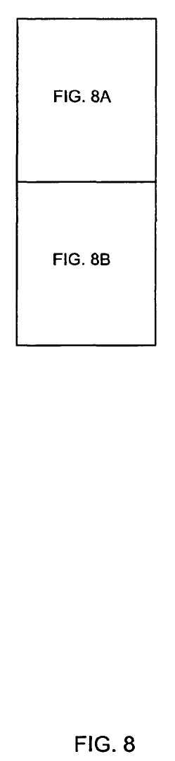

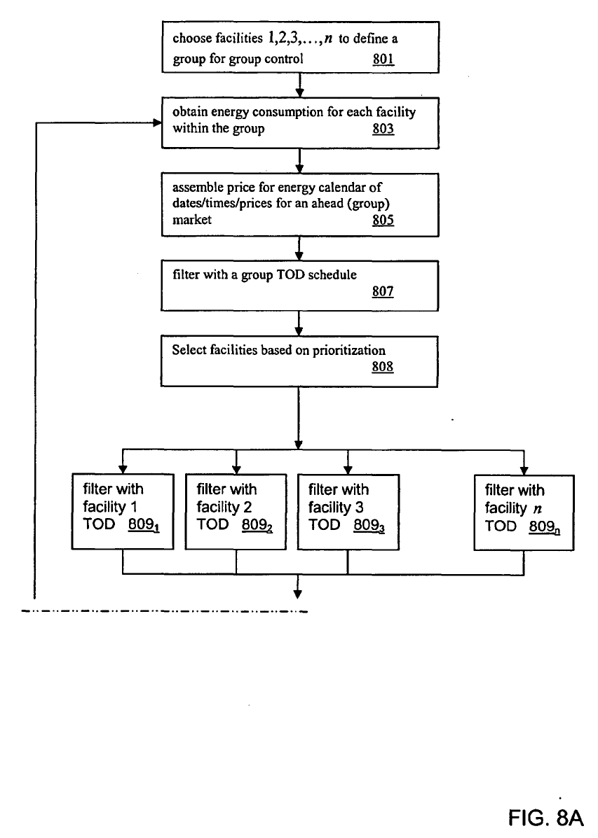

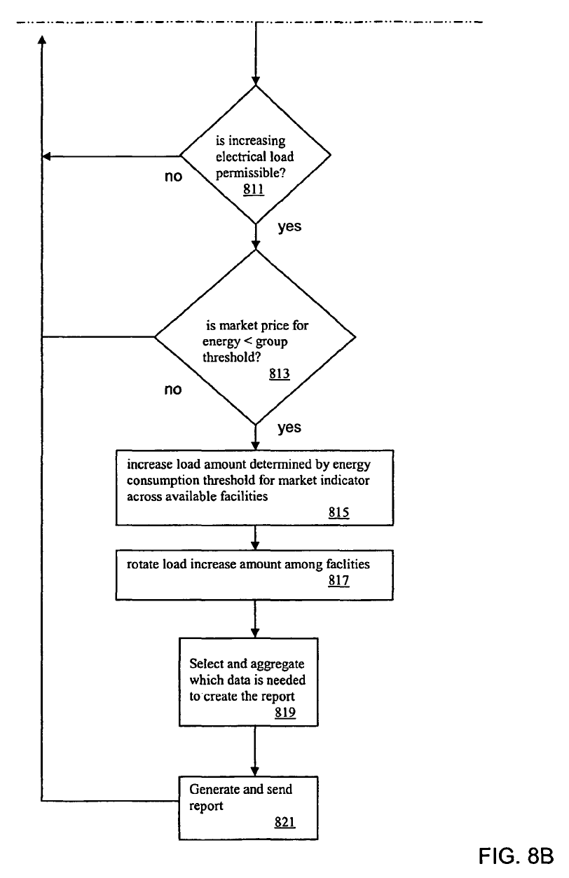

A reciprocal of the previous group control is shown in FIG. 8 and may be performed to increase load for periods outside of the TOD to anticipate shedding. Similar to load reduction (steps 801, 803, 805, 807), outside of the TOD, stepped-response shedding, smart defrost and anticipatory shedding may be optimized.

The application examines the group and facility TODs (steps 807, 8091, 8092, 8093, . . . , 809n) if a load increase is allowed (step 811). The application will set assign facilities within the group a priority based upon their ability to consume load, and the length of time the particular loads within the facility may be increased (step 808). If the current market indicator is less than a group energy threshold (step 813), the application will correspond the group energy threshold with a predetermined amount of load that may be consumed during that time. The predetermined amount of load to be consumed is distributed across the members of that group (step 815).

The application calculates a total group load increase based upon which loads were shed, and a before and after reading of each facility's power (step 817).

After a group has initiated reciprocal control, a report may be generated describing the increased consumption measures taken by the group, in addition to any related energy pricing information (steps 819, 821). The report may be forwarded in accordance with any notification configuration for that facility.

One or more embodiments of the present invention have been described. Nevertheless, it will be understood that various modifications may be made without departing from the spirit and scope of the invention. Accordingly, other embodiments are within the scope of the following claims.

What is claimed is:

1. A method of controlling energy consumption for a facility comprising:
setting at least one energy reduction threshold;
monitoring a market indicator for energy supplied to the facility;
providing a time of day schedule for the facility wherein the schedule determines available time periods when the facility may reduce energy consumption; and
shedding facility loads corresponding to at least one energy reduction threshold if the energy reduction threshold is less than said market indicator and said time of day schedule allows for shedding.

2. The method according to claim 1 further comprising:
acquiring future energy market indicator information for the facility; and
providing a market indicator for energy calendar from the acquired energy market price information for the facility.

3. The method according to claim 2 further comprising:
acquiring current and forecast weather information; and
providing a weather calendar for the facility.

4. The method according to claim 3 further comprising subscribing to entities for the market indicator and weather information.

5. The method according to claim 4 wherein the facility loads include refrigeration loads.

6. The method according to claim 5 wherein the time of day schedule comprises days and times for forthcoming calendar months that un-noticeable shed events are allowed.

7. The method according to claim 6 wherein the time of day schedule comprises days and times for forthcoming calendar months that noticeable shed events are allowed.

8. The method according to claim 7 further comprising identifying each sheddable load at the facility by equipment identification and load amount.

9. The method according to claim 8 further comprising limiting the time that each sheddable load may be shed for a maximum or minimum.

10. The method according to claim 9 further comprising identifying categories of use for each sheddable load.

11. The method according to claim 10 further comprising assigning a priority to each sheddable load.

12. The method according to claim 11 further comprising assigning at least one sheddable load to at least one level.

13. The method according to claim 12 wherein each level further comprises a predetermined sheddable load amount for the facility.

14. The method according to claim 13 wherein each level further comprises an energy reduction threshold wherein each level has a different energy reduction threshold and functions as a step-response load shed in response to increasing market indicators.

15. The method according to claim 14 further comprising retrieving at least one refrigeration defrost times schedule for at least one refrigeration load for the facility.

16. The method according to claim 15 further comprising creating a first cost metric based on at least one refrigeration defrost times schedule in conjunction with the market indicator at those defrost times.

17. The method according to claim 16 further comprising creating a second cost metric based on at least one refrigeration defrost times schedule but at times when the market indicator is less using the energy cost calendar.

18. The method according to claim 17 further comprising comparing the second cost metric against the first cost metric to indicate defrost energy savings.

19. The method according to claim 18 further comprising providing a revised defrost times schedule for at least one refrigeration load for the facility.

20. The method according to claim 19 further comprising presenting the revised defrost times schedule with the defrost energy savings to the facility for acceptance.

21. The method according to claim 20 further comprising comparing a facility temperature setpoint with the weather calendar.

22. The method according to claim 21 further comprising:
comparing an energy reduction threshold with a market indicator for energy supplied to the facility;
retrieving the weather calendar if the market price for energy is greater than the energy reduction threshold; and
adjusting at least one temperature setpoint a predetermined number of degrees, higher or lower corresponding to cooling or heating, for temperature controlling equipment located at the facility in correspondence with the weather calendar to reduce anticipated facility energy consumption.

23. The method according to claim 22 further comprising subscribing to an energy provider for a demand response program.

24. The method according to claim 23 further comprising:
acknowledging receipt of demand response notices; and
shedding sheddable loads at the facility based on an agreed load amount.

25. The method according to claim 24 further comprising:
checking a record of the facility's energy consumption against a third party's record;
calculating a difference between the facility's energy consumption record and the third party's record; and
adjusting a power metering conversion multiplier for the facility based on the difference.

26. The method according to claim 25 further comprising:
choosing a plurality of facilities as a group for group control;
setting at least one group energy reduction threshold;
monitoring a market indicator for energy supplied to the group;
providing a time of day schedule for the group wherein the schedule determines available time periods when the group may reduce consumption; and
for each facility in the group, shedding facility loads as determined by the group control corresponding to at least one energy reduction threshold if the energy reduction threshold is less than the market price for energy and the group time of day schedule and each facility time of day schedule allows for shedding.

27. The method according to claim 26 further comprising:
acquiring future energy market price information for the group; and
providing a price for energy calendar from the acquired energy market price information for the group.

28. The method according to claim 27 wherein the amount of load shed by each facility in the group is determined by a load amount determined by at least one group energy reduction threshold price divided among the facilities in the group that allow load shedding.

29. The method according to claim 28 wherein the amount of load shed by each facility in the group is determined by a load amount determined by at least one group energy reduction threshold divided unequally among the facilities in the group that allow load shedding.

30. The method according to claim 29 wherein the unequal load amounts for the group facilities that allow load shedding are rotated within all group facilities in the group.

31. A method of controlling energy consumption for a facility comprising:
setting at least one energy reduction threshold;
monitoring a market indicator;
communicating with a control interface at a facility for the purpose of energy reduction; and
reducing energy consumption at a facility using the control interface upon receipt of a market indicator if the energy reduction threshold is less than the market indicator.

32. The method according to claim 31 wherein the market indicator is a demand response signal.

33. The method according to claim 31 wherein the market indicator is a future market price.

34. The method according to claim 31 wherein the market indicator is a spot market price.

35. The method according to claim 31 wherein the market indicator is a signal from a utility.

36. The method according to claim 31 wherein the market indicator is a requested amount of kilowatt reduction.

37. The method according to claim 31 further comprising storing market information for a facility to curtail energy.

38. The method according to claim 37 further comprising:
receiving a market indicator;
comparing the market indicator to a predefined curtailment amount; and
initiating a corresponding energy reduction.

39. The method according to claim 38 further comprising sending instructions to at least one control device at a facility to reduce energy consumption based on a market indicator.

40. The method according to claim 39 further comprising storing energy reduction information to verify the energy reduction.

41. The method according to claim 40 wherein the energy reduction information includes energy consumption.

42. The method according to claim 40 wherein the energy reduction information includes an amount of kilowatts reduced.

43. The method according to claim 40 wherein the energy reduction information includes a comparison of market prices to energy reduction and reporting financial savings.

44. The method according to claim 40 further comprising displaying a report on market savings and energy savings as a direct result of the energy reduction.

45. The method according to claim 40 further comprising sending an email report on market savings and energy savings.

46. The method according to claim 31 further comprising:
communicating with a facility; and
sending facility information related to reducing energy.

47. The method according to claim 46 wherein the facility information related to reducing energy is meter data.

48. The method according to claim 46 wherein the facility information related to reducing energy is an amount of kilowatts reduced.

49. The method according to claim 31 further comprising:
obtaining market indicators; and
reducing energy at a facility by comparing market indicators to energy reduction thresholds.

50. The method according to claim 49 further comprising receiving market indicators to obtain market indicators.

51. The method according to claim 50 further comprising assigning at least one generation amount or at least one energy reduction amount to at least one level related to a market indicator for a facility.

52. The method according to claim 51 wherein each level is assigned a different energy reduction threshold and reduces energy in response to market indicators.

53. The method according to claim 31 further comprising:
subscribing to an energy provider for a demand response program;
acknowledging receipt of demand response notices; and
reducing energy for at least one facility.

54. The method according to claim 31 further comprising:
checking a record of a facility's energy consumption against a third party's record;
calculating a difference between the facility's energy consumption record and the third party's record; and
adjusting a power metering conversion multiplier for the facility based on the difference.

55. The method according to claim 54 further comprising verifying kilowatts reduced as a result of an energy reduction event.

56. The method according to claim 31 further comprising:
choosing a plurality of facilities as a group for group control; and
setting at least one group energy reduction threshold for the group.

57. The method according to claim 56 further comprising:
acquiring future energy market price information for the group; and
providing a price for energy calendar from the acquired energy market price information for the group.

58. The method according to claim 31 further comprising selecting the highest market indicator times to reduce electrical consumption within a maximum time duration given for that facility.

59. The method according to claim 31 further comprising responding to retail market prices for energy when it is economical to initiate facility power generation for the purpose of reducing supplied energy.

60. The method according to claim 31 further comprising:
dividing a total energy reduction required by a plurality of facilities; and
deciding which facilities will participate based on energy availability at the facilities.

61. The method according to claim 60 further comprising determining energy available at a facility based on which facilities did not participate in a previous energy reduction event.

62. The method according to claim 31 further comprising:
assigning electrical loads participating in energy reduction to aggregate particular types of loads; and
assigning a priority to each electrical load.

63. The method according to claim 31 wherein an energy reduction amount required from a group of facilities is rotated within all facilities in the group.

64. The method according to claim 31 further comprising for a required energy reduction amount, rotating electrical loads that are approved to participate in energy reduction.

65. The method according to claim 31 further comprising rotating the reduction of lighting for the purpose of extending lighting equipment life.

66. The method according to claim 31 further comprising bidding a facility's reduction in energy consumption on an energy market as a generation source.

67. The method according to claim 31 further comprising:
monitoring energy reduction at each facility; and
controlling a total aggregated energy reduction amount by changing a facility's participation level.

68. The method according to claim 67 wherein aggregated energy reduction is grouping individual sites into a single aggregated energy amount for aggregated kilowatt reduction.

69. The method according to claim 68 further comprising setting individual participation levels for each facility within a group to achieve a group's aggregated participation level.

70. The method according to claim 69 further comprising prioritizing facilities within a group for energy reduction based on an economic impact of the energy reduction for individual facilities.

71. The method according to claim 70 further comprising selecting the energy reduction threshold for a facility based on user defined values.

72. The method according to claim 71 wherein a user defined value is an amount of energy reduction.

73. The method according to claim 72 wherein a user defined value is a market indicator.

74. The method according to claim 73 wherein a user defined value is a time of day that a facility is allowed to reduce energy consumption.

75. The method according to claim 74 wherein a user defined value is a minimum and a maximum time that energy within a facility is allowed to be reduced.

76. The method according to claim 75 further comprising initiating additional energy reduction at a facility with multiple levels of participation due to early termination of a level based on maximum times being exceeded.

77. The method according to claim 76 wherein a user defined value is a seasonal value.

78. The method according to claim 77 further comprising determining seasonal values by outside air temperature.

79. The method according to claim 78 further comprising determining seasonal values by referencing postal codes for a facility via a network to obtain weather information.

80. The method according to claim 79 further comprising determining seasonal values by calendar date.

81. The method according to claim 31 wherein a control interface is a building automation system.

82. The method according to claim 31 wherein a control interface is a lighting control system.

83. The method according to claim 31 wherein a control interface is a facility controller.

84. The method according to claim 31 wherein a control interface is an environmental control system.

85. The method according to claim 31 wherein a control interface is an energy management system.

86. The method according to claim 31 wherein a control interface is a process controller.

87. The method according to claim 31 further comprising sending an energy reduction signal to a facility.

88. The method according to claim 87 further comprising sending an energy reduction signal to multiple groups of facilities.

89. The method according to claim 31 further comprising sending notification of a facility's upcoming energy reduction events to that facility.

90. The method according to claim 31 further comprising sending notification of a facility's current energy reduction event to that facility.

91. A method of controlling energy consumption for a facility comprising:
setting at least one energy reduction threshold;
monitoring a market indicator and reducing energy consumption upon receipt of a market indicator; and
using a time of day schedule that determines the times and days that curtailable energy is available.

92. The method according to claim 91 wherein the time of day schedule comprises days and times for forthcoming calendar months that un-noticeable shed events are allowed.

93. The method according to claim 91 wherein the time of day schedule comprises days and times for forthcoming calendar months that noticeable shed events are allowed.

94. The method according to claim 91 further comprising limiting the time when curtailable energy is available to a maximum or a minimum.

95. The method according to claim 91 further comprising decreasing or increasing electrical energy prioritized based on seasonal values.

96. The method according to claim 95 further comprising determining seasonal values from outside air temperature.

97. The method according to claim 96 further comprising determining seasonal values by referencing a facility's postal code via a network to obtain weather information for the facility.

98. The method according to claim 97 further comprising determining seasonal values by date.

99. The method according to claim 91 wherein the energy reduction threshold is determined by seasonal values.

100. The method according to claim 91 wherein the energy reduction for curtailment is determined by seasonal criteria.

101. The method according to claim 91 further comprising:
matching a facility's zip code to a latitude/longitude location and date to determine daylight values, and;
determining the availability of electrical load in a facility for curtailment.

102. The method according to claim 101 further comprising combining seasonal values with ambient light information to determine what electrical loads are available for curtailment.

103. A method of controlling energy consumption for a facility comprising:
setting at least one energy reduction threshold;
monitoring a market indicator and reducing energy consumption upon receipt of market indicator; and
retrieving at least one refrigeration defrost schedule for at least one refrigeration system.

104. The method according to claim 103 wherein energy reducing defrost time schedules are adjusted to provide defrosts during energy curtailment events.

105. The method according to claim 104 wherein energy reducing defrosts are time off defrosts.

106. The method according to claim 103 wherein energy consuming defrost time schedules are adjusted to prevent defrost during energy curtailment events.

107. The method according to claim 106 wherein the defrost time schedule adjustment includes canceling the defrost event.

108. The method according to claim 106 wherein the defrost time schedule adjustment includes delaying the defrost event.

109. The method according to claim 106 wherein the defrost time schedule adjustment includes early execution of the defrost event.

110. The method according to claim 106 wherein energy consuming defrosts are further defined as electric defrost.

111. The method according to claim 106 wherein energy consuming defrosts are further defined as hot gas defrosts.

112. The method according to claim 103 further comprising creating a first schedule based on at least one refrigeration defrost schedule in conjunction with the energy market indicator for those defrost times.

113. The method according to claim 112 further comprising creating a second schedule based on at least one refrigeration defrost schedule at times when there is no energy market indicator.

114. The method according to claim 113 further comprising comparing the second schedule against the first schedule to indicate defrost energy savings.

115. The method according to claim 114 further comprising presenting a revised defrost times schedule with the defrost energy savings to the facility for acceptance.

116. The method according to claim 103 further comprising using a market indicator to adjust at least one temperature setpoint a predetermined number of degrees for temperature controlling equipment located at the facility in correspondence with the weather calendar to reduce anticipated facility energy consumption.

117. A method of controlling energy consumption for a facility comprising:
setting at least one energy threshold;
monitoring a market indicator;
communicating with a control interface at a facility for the purpose of increasing energy consumption; and
increasing energy consumption at a facility using the control interface upon receipt of a market indicator if the energy reduction threshold is greater than the market indicator.

118. The method according to claim 117 further comprising:
acquiring forecast weather information;
providing a weather calendar for the facility; and
increasing energy consumption based on weather data.

119. A method of energy curtailment that uses audio or video messages to notify building occupants of an intended energy reduction event at one or more facilities.

120. The method according to claim 119 further comprising an audio or video message with customizable information based on energy saved for at least one facility.

121. The method according to claim 120 further comprising customizable information based on air quality.

122. The method according to claim 119 further comprising: customizable information based on energy savings as a result of the energy reduction.

123. The method according to claim 119 further comprising the use of a text-to-speech to automatically customize audio and video messages.

124. The method according to claim 119 wherein the audio or video message fading in and out of any audio or video the facility is currently playing.

125. The method according to claim 119 further comprising audio and video files capable of being uploaded to a facility or groups of facilities from a remote location.

126. The method according to claim 119 further comprising multiple audio or video messages played at customizable intervals during the same curtailment event.

127. The method according to claim 119 further comprising selecting different audio or video messages based on energy reduction information.

128. The method according to claim 127 wherein reduction information is market indicators.

129. The method according to claim 127 wherein reduction information is different levels of curtailment.

130. The method according to claim 127 wherein reduction information is seasonal values.

131. The method according to claim 127 wherein reduction information is temperature.

132. The method according to claim 127 wherein reduction information is time of day scheduling.

133. The method according to claim 127 wherein reduction information is whether the energy reduction will be noticed by occupants.

134. A method of controlling energy consumption for a facility by defining an air quality range acceptable to reduce energy within at least one facility.

135. The method according to claim 134 further comprising:
monitoring air quality levels; and
comparing the air quality levels to acceptable air quality levels.

136. The method according to claim 135 wherein acceptable air quality levels are defined by carbon dioxide levels.

137. The method according to claim 136 wherein acceptable air quality levels are defined by carbon monoxide levels.

138. The method according to claim 137 wherein acceptable air quality levels are defined by moisture levels.
